(19) United States
(12) Patent Application Publication
(10) Pub. No.: US 2023/0082046 A1
(43) Pub. Date: Mar. 16, 2023

(54) INFORMATION PROCESSING DEVICE, INFORMATION PROCESSING SYSTEM, INFORMATION PROCESSING METHOD, AND PROGRAM

(71) Applicant: GarageBank Corporation, Tokyo (JP)

(72) Inventors: Gakuyo ISODA, Tokyo (JP); Yoshihito YAMAMOTO, Tokyo (JP)

(21) Appl. No.: 17/760,142

(22) PCT Filed: Dec. 9, 2020
(86) PCT No.: PCT/JP2020/045904

§ 371 Date: Aug. 4, 2022

(30) Foreign Application Priority Data
Feb. 6, 2020 (JP) 2020-029873
Nov. 16, 2020 (JP) 2020-190034

(51) Int. Cl. G06Q 30/06; G06V 10/764; G06V 30/19; G06V 30/42; G06V 20/00

(52) U.S. Cl. CPC G06Q 30/0645; G06V 10/764; G06V 30/19173; G06V 30/42; G06V 20/95

(57) ABSTRACT

An information processing device 1 includes an assessment unit 12-2 that acquires information on an object of a user through a network N, and acquires a purchase price based on the information on the object at the time of purchasing the object, a contract unit 12-3 that gives a notification of a purchase price, a lease charge when leasing the object to be purchased to a user, and various conditions relating to a lease contract through the network, and accepts the lease contract, and a contract management unit 12-5 that pays the purchase price to a user, accepts payment of the lease charge, and manages a lease charge payment situation. A user can raise a fund corresponding to the purchase price with easy means of transmitting information on the object through the network N.

### TECHNICAL FIELD

The present invention relates to an information processing device, an information processing system, an information processing method, and a program which are configured to provide a service to a user.

### BACKGROUND ART

Currently, as a representative method in which users raise a fund by using their own items, there are following two methods. A first method is a method of raising a fund with a purchase amount when possessions are made to be purchased by putting the possessions for auction, selling the possessions at a flea market, selling the possessions at a recycle shop, or through other means. A second method is a method of raising a fund corresponding to an assessment price by depositing items to a pawnshop. It can be said that any of the methods is recognized to many people and is widely spread.

### SUMMARY OF THE INVENTION

### Technical Problem

However, since the first method is premised on selling of an item, after a user sells the item, there is a problem that the item does not remain in user's hands, and the user cannot use the item thereafter. In addition, in the second method, the ownership of an item is retained by an owner, but there is a problem that the item does not remain in user's hands, and the user cannot use the item as in the first method until the user pays a predetermined amount of money to get back the item. Furthermore, it is necessary for the user to take a step of visiting the store during business hours (or making a request for an assessor to visit own house), a step of handing over the item, to the assessor in a face-to-face manner, and a step of allowing the assessor to assess the item, and thus a burden on the user is large, and it is difficult for the user to easily use the method.

The invention has been made to solve the problem, and an object thereof is to provide a new service that is capable raising a fund while maintaining a state in which a user can use an item, and can be easily used by the user.

### Solution to Problem

To solve the problem, according to an aspect of the invention, information on an object owned by a user is acquired, a purchase price is acquired on the basis of the acquired information on the object, the user is notified of the acquired purchase price, a lease charge when leasing the object to be purchased to the user, and various conditions relating to a lease contract to accept the lease contract, the purchase price is paid to the user, payment of the lease charge is accepted, and a user's lease charge payment situation based on the lease contract is managed.

In addition, according to the present application, a reception unit, an assessment unit, a contract unit, and a money transfer management unit, and a contract management unit are provided. The reception unit receives information of an object for which a service is desired, and on individual information on the user from the user. The assessment unit derives the purchase price on the basis of the information on the object which is received by the reception unit, and the received individual information. The contract unit transmits the purchase price derived by the assessment unit, a lease charge when leasing a corresponding item to the user, and various contract conditions to the user, and executes the contract. The contract management unit manages a payment situation of the lease contract concluded in the contract unit, and transfers an ownership to the user when the contract expires. In a case where payment of the lease charge is delayed or the user desires to cancel the lease contract, the contract management unit takes a step of preparing recovery of the leased item at that point of time to expire the lease contract.

In the contract management unit, even in a case where delay in payment of the lease charge occurs, the lease contract may be held on the basis of a user's situation, and extension oil a payment acceptance period of the lease charge may be suggested to the user. Even in a situation in which the user cannot perform payment according to the contract due to a certain reason, an action history based on user's past usage is digitized in a diversified manner, how much the value exceeds a reference is measured, and a measure such as special postponement is taken in correspondence with the situation. This contributes to lowering a psychological barrier of a user when providing a service, which is mainly targeted at real estate, automobiles, and corporations, to general users through a communication network.

### Advantageous Effects of the Invention

According to the invention configured as described above, the user can raise a fund corresponding to a purchase price by easy means of transmitting information on an object owned by the user through a network without actually going to a store or without interacting with an assessor in a face-to-face manner. In addition, provision of the purchase price to the user is based on a lease contract that is concluded after the purchase price, the lease charge, and the various conditions relating to the lease contract are presented to the user through a network, and the user can raise a fund while maintaining a state in which the object can be used under the condition of payment of the lease charge.

### BRIEF DESCRIPTION OF THE DRAWINGS

FIG. 1 is a view illustrating a configuration example of an information processing system according to a first embodiment.

FIG. 2 is a view illustrating a configuration example of an information processing device according to the first embodiment.

FIG. 3 is a flowchart illustrating a procedure that is executed by the information processing device.

FIG. 4 is a view illustrating a configuration example of an information processing system according to a second embodiment.

FIG. 5 is a view illustrating a configuration example of an information processing device and a user terminal according to the second embodiment.

FIG. 6 is a view illustrating contents of a record of each database.

FIG. 7 is a flowchart illustrating an operation example of the information processing system.

FIG. 8 is a view illustrating an example of an item distribution tree.

FIG. 9 is a view illustrating various screens displayed on the user terminal.

FIG. 10 is a view illustrating various screens displayed on the user terminal.

FIG. 11 is a view illustrating a screen displayed on the user terminal.

FIG. 12 is a flowchart illustrating an operation example of the information processing system.

FIG. 13 is a flowchart illustrating an operation example of the information processing system.

FIG. 14 is a view illustrating a screen displayed on the user terminal.

### MODE FOR CARRYING OUT THE INVENTION

### First Embodiment

Hereinafter, a first embodiment of the invention will be described with reference to the accompanying drawings.

“1. Configuration of Information Processing System 100”

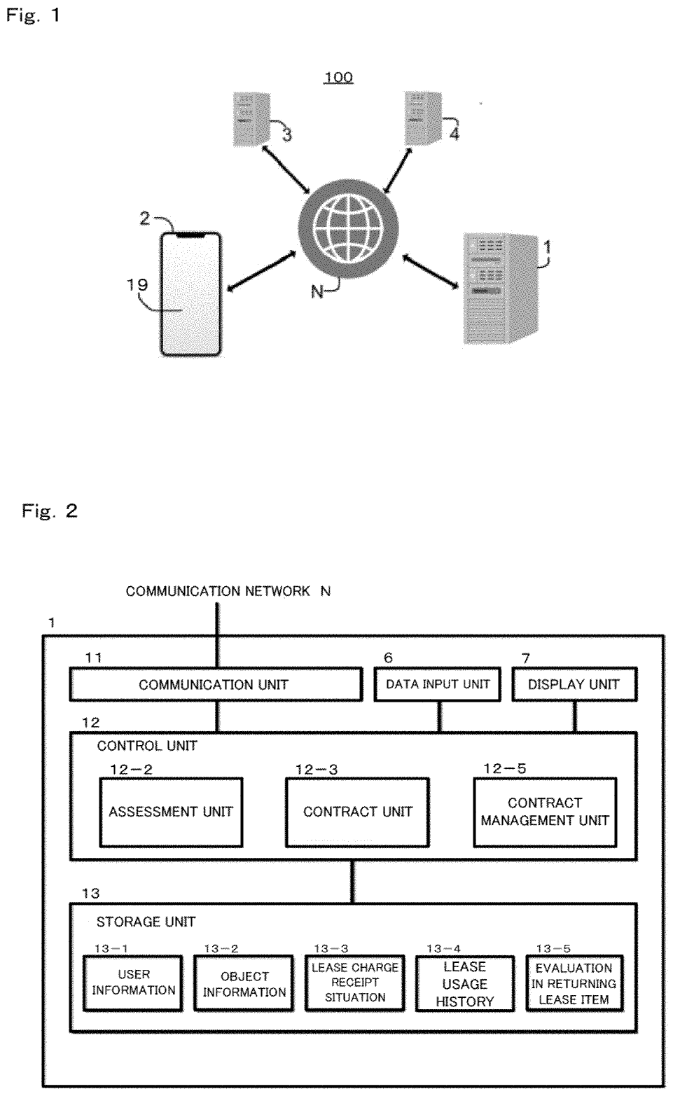

A configuration of an information processing system 100 will be described with reference to FIG. 1. The invention has been made to provide a service of buying an object from a user and of leasing the object to the user. FIG. 1 is a view illustrating a configuration example of the information processing system 100 according an embodiment. The information processing system 100 includes an information processing device 1, a user terminal 2, a guarantee taking-over company's server device 3, and a market price information DB device 4. The various devices are connected to each other in a communication possible manner through a network N.

The information processing device 1 is a computer having a function of transmitting and receiving a file, data, or the like to and from the user terminal 2, the guarantee taking-over company's server device 3, and the market price information DB device 4 through the network N, and includes a data input unit 6 such as a keyboard and a mouse, a display unit 7 such as a monitor that displays data, a communication unit 11 that transmits and receives data through the network N, a storage unit 13 that stores various pieces of data or files, and a processing program, and respective processing units such as a control unit 12 that controls the processing unit in accordance with the processing program stored in the storage unit 13.

It cannot be said that the information processing device 1 is constituted by one computer. It is considered that a plurality of computers or servers are connected directly or through the network N and cooperate with each other to perform information processing.

The user terminal 2 is an information terminal such as a smartphone and a personal computer owned by a user, and when being enabled to communicate with the information processing device 1 by downloading an application program for using a service or through an Internet browser and through the network N, the user terminal 2 can transmit and receive information and can receive a service.

When being enabled to communicate with the information processing device 1 through the network N, the guarantee taking-over company's server device 3 can transmit and receive information. Information on the individual of the user, information of an object to be leased after purchase, and the price thereof are transmitted to the guarantee taking-over company's server device 3, and are examined by the guarantee taking-over company. A company to be connected is not limited to one company, and connection can be made to computers of respective companies to use services of a plurality of companies in some cases.

When being enabled to communicate with the information processing device 1 through the network N, the market price information DS device 4 can perform transmission and reception of information. The market price information DB device 4 is a database device of market price information of an item such as a movable property, and expresses market price information with numerical values on the basis of information transmitted from the information processing device 1 such as a brand name, a product name, and information on a ranked appearance state, and transmits the numerical value to the information processing device 1.

<<2. Configuration of Information Processing Device 1>>

Next, a configuration of the information processing device 1 will be described with reference to FIG. 2. In the drawing, the configuration of the information processing device 1 according to the embodiment is illustrated, only constituent elements necessary for explanation are illustrated, and typical constituent elements are omitted.

The information processing device 1 includes the communication unit 11, the control unit 12, and the storage unit 13.

The communication unit 11 is connected to the network N, and transmits and receives information to and from the user terminal 2, the guarantee taking-over company's server device 3, and the market price information DB device 4 through the network N.

The control unit 12 is a controller and is realized when various programs stored in a storage device are executed. As illustrated in FIG. 2, the control unit 12 includes an assessment unit 12-2, a contract unit 12-3, and a contract management unit 12-5.

The storage unit 13 is realized by a storage device such as a hard disk drive, and stores user information 13-1, object information 13-2, a lease charge receipt situation 13-3, a lease usage history 13-4, and evaluation in returning lease item 13-5 in the example in FIG. 2.

The assessment unit 12-2 receives information on the individual of a user and information of an object for which a service is desired which are transmitted from, the user, and stores respective pieces of information in the user information 13-1 and the object information 13-2.

Examples of the information of the object for which a service is desired include a genre, a brand name, a product name, information on a ranked appearance state, and an object photograph captured in the user terminal 2. The quantity of information to be transmitted is different depending on the genre of an item.

The assessment unit 12-2 reads out the information stored in the user information 13-1, and investigates that there is no data that matches this user from data stored in the lease usage history 13-4 and the evaluation in returning lease item 13-5.

In a case of matching, when the matching user fails below a certain score in accordance with the following scoring, the gist indicating that acceptance is impossible is displayed on a screen 19 of the user terminal 2.

In a case where there is no matching, or in a case where the matching user exceeds a certain score in accordance with the following scoring when matching exists, information of an object for which a service is desired and which is stored in the object, information 13-2 is read out, and a purchase price is calculated. When calculating the purchase price, an inquiry is made to the market price information DB device 4 through a communication unit and the network N. The market price information DB device 4 is a database for acquiring market price information at a used item market for each maker and each kind of product. A price obtained by multiplying the price information acquired in this database by a predetermined rate is set as the purchase price. However, a configuration that determines whether or not acceptance is possible by using the score is not essential, and a configuration that does not perform the determination may be employed.

The contract unit 12-3 reads out the purchase price derived by the assessment unit 12-2, information on a user which is stored in the user information 13-1, and information of an object for which a service is desired which is stored in the object information 13-2, and makes an inquiry to the guarantee taking-over company's server device 3.

In a case where a guarantee acceptance reaction is obtained from a guarantee company, the purchase price derived by the assessment unit 12-2, a lease charge derived by multiplying the price by a predetermined rate, and various conditions relating to contract are displayed on the screen 19 of the user terminal 2. A button on which the gist indicating execution of purchase/lease is written is disposed in combination on the same screen. When a user presses the button, purchase/lease contract is concluded. However, guarantee acceptance by the guarantee taking-over company is not essential, and a purchase price or the like may be presented to a user and the process may be proceeded without examination of the guarantee taking-over company (arbitrary alternative means is also possible).

The contract management unit 12-5 immediately pays the purchase price that is concluded in the contract unit 12-3 to the user. The price is reflected on a digital wallet stored in the user information 13-1, and the user can use the same amount of money as an electronic money to meet a purchase fund of items. In addition to this, the user can transfer the money to a bank account or can withdraw the money from a cooperated ATM by using a withdrawal function.

In addition, a lease charge paid by the user is received. Information on date and time in payment, and the amount of money are stored in the lease charge receipt situation 13-3.

The contract management unit 12-5 reads out information from the user information 13-1, the object information 13-2, and the lease charge receipt situation 13-3, and supervises whether or not lease contract is proceeding appropriately. When the lease charge is paid without delay and the lease reaches maturity, the lease contract is terminated, the ownership of the lease object is transferred to the user, and notification of the gist is given to the screen IS of the user terminal 2. In a case where the lease contract is terminated, the gist is stored in the lease usage history 13-4.

When the user makes a request for cancellation of the lease contract during a lease contract period, a step of recovering the lease object from the user in order to terminate the lease contract. After termination of the lease contract, information is read out from the object information 13-2 and the lease charge receipt situation 13-3, and the information is stored in the lease usage history 13-4 in combination with data indicating that the contract is terminated in which type.

In a case where payment of the lease charge is delayed during the lease contract period, data stored in the lease usage history 13-4 and the evaluation in returning lease item 13-5 is read out, and in a case where the user exceeds a certain score in accordance with the following scoring, the gist indicating that a lease charge acceptance period can be extended is displayed on the screen 19 of the user terminal 2.

In a case where the user falls below a certain score, a step of recovering the lease object from the user is taken in order to terminate the lease contract. After termination of the lease contract, information is read out from the object information 13-2 and the lease charge receipt situation 13-3, and the information is stored in the lease usage history 13-4 in combination with data indicating that the contract is terminated in which type.

The user information 13-1 stores individual information or digital wallet information of the user.

The object information 13-2 stores information of the lease object.

The lease charge receipt situation 13-3 stores the amount of money paid as the lease charge, and information of a reception date.

The lease usage history 13-4 records a record of usage frequency of this service for the user, lease charge payment timing, and a lease contract violation rate in the past.

The evaluation in returning lease item 13-5 accepts writing of a record indicating whether the returned lease item is genuine, whether there is no difference from an applied category, whether an external appearance state is as declared, whether there is no failure, and whether the item is returned on time.

The scoring is based on data stored in the lease usage history 13-4 and the evaluation in returning lease item 13-5. There is a reference point for each item, and a positive point is scored when exceeding the reference, a negative point is scored when failing below the reference point, and the total point is scored.

<<3. Procedure of Information Processing Device 1>>

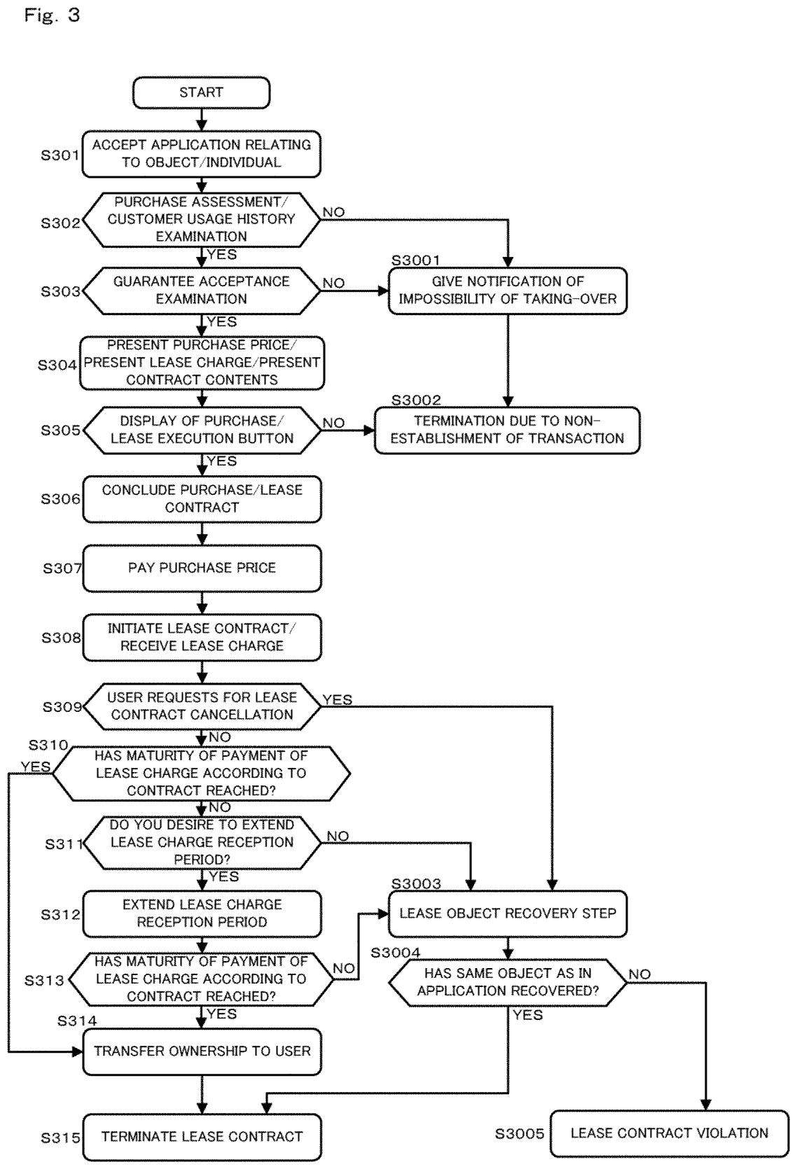

Next, a procedure that is executed by the information processing device 1 will be described. FIG. 3 is a flowchart illustrating a procedure that is executed by the information processing device 1 according to the embodiment.

Information on an object or an individual is received from a user who desires to use a service, and application is accepted (step S301), examination of a customer usage history is performed and a purchase price is calculated when there is no problem in a score in accordance with the above-described scoring (Step 3302, YES), and guarantee acceptance examination is requested (step 3303).

In a case where there is a problem in a score in the customer usage history examination step (step S302, NO), a screen for giving a notification of impossibility of taking-over is displayed on the screen 19 of the user terminal 2 (step S3001), and transaction is not established (step S3002).

In the guarantee acceptance examination in step S303, in a case where the guarantee acceptance is not approved (step S303, NO), a screen for giving a notification of impossibility of taking-over is displayed on the screen 19 of the user terminal 2 (step S3001) as described above, and transaction is not established (step S3002).

In the guarantee acceptance examination in step S303, in a case where the guarantee acceptance is approved (step S303, YES), a purchase price, a lease charge, and contract contents are displayed on the screen 19 of the user terminal 2 (step S304), and a button on which the gist indicating execution of purchase/lease is written is also displayed (step S305).

In a case where a user transmits a purchase/lease execution reaction (step S305, YES), a purchase/lease contract is concluded (step S306), and a purchase price is paid to a digital wallet stored in the user information 13-1 in the information processing device 1 (step S307).

In step S305, in a case where the user transmits a cancellation reaction (step S305, NO), the transaction is not established (step S3002).

Lease contract is initiated simultaneously with payment in step S307, and the user is obliged to pay a lease charge (step S308). During the lease contract, the user can freely request lease contract cancellation (step S309, YES). In this case, the user needs to return the lease object to a service providing company (step S3003). In a case where the recovered object is the same as an object declared at the time of contract (step S3004, YES), the lease contract is terminated (S315). However, the recovered object is different from the object that is declared at the time of contract (step S3004, NO), the lease contract is violated (step S3005).

In a case where the user does not request lease contract cancellation (step S309, NO), and in a case where the lease charge is paid as in contract, and maturity is reached (Step S310, YES), the ownership is handed over to the user (step S314), the gist is displayed on the screen 19 of the user terminal 2, and the lease contract is terminated (step S315).

In a case where the lease charge is not paid as in the contract (step S310, NO), and the score exceeds a certain reference in accordance with the above-described scoring, the gist indicating that a lease charge acceptance period can be extended is given in notification on the screen 19 of the user terminal 2 (step S311). In a case where the user shows a reaction indicating that the user does not desire the extension (step S311, NO), the user returns the lease object to the service providing company (step S3003) (the subsequent process is the same as described above).

In step S311, in a case where the user shows a reaction indicating the user desires the extension (step S311, YES), the lease charge acceptance period is extended (step S312). An extension period is calculated by using the above-described score. In a case where the lease charge is paid within the period, and the lease reaches maturity without delay of payment (step S313, YES), the ownership is transferred to the user (step S314), and the gist is displayed on the screen 19 of the user terminal 2, and the lease contract is terminated (step S315).

In step S313, in a case where payment is subsequently delayed, the gist indicating recover of the lease object is given in notification on the screen 19 of the user terminal 2 (step S313, NO), and the user returns the lease object to the service providing company (step S3003) (the subsequent process is as described above).

In a case where the lease charge payment cannot be received as in the contract (step S310, NO), and the score fails below a certain reference in accordance with the above-described scoring, the gist, indicating that the lease object is recovered is given in notification on the screen 19 of the user terminal 2 (step S311, NO), and the user returns the lease object to the service providing company (step S3003) (the subsequent process is as described above).

### Second Embodiment

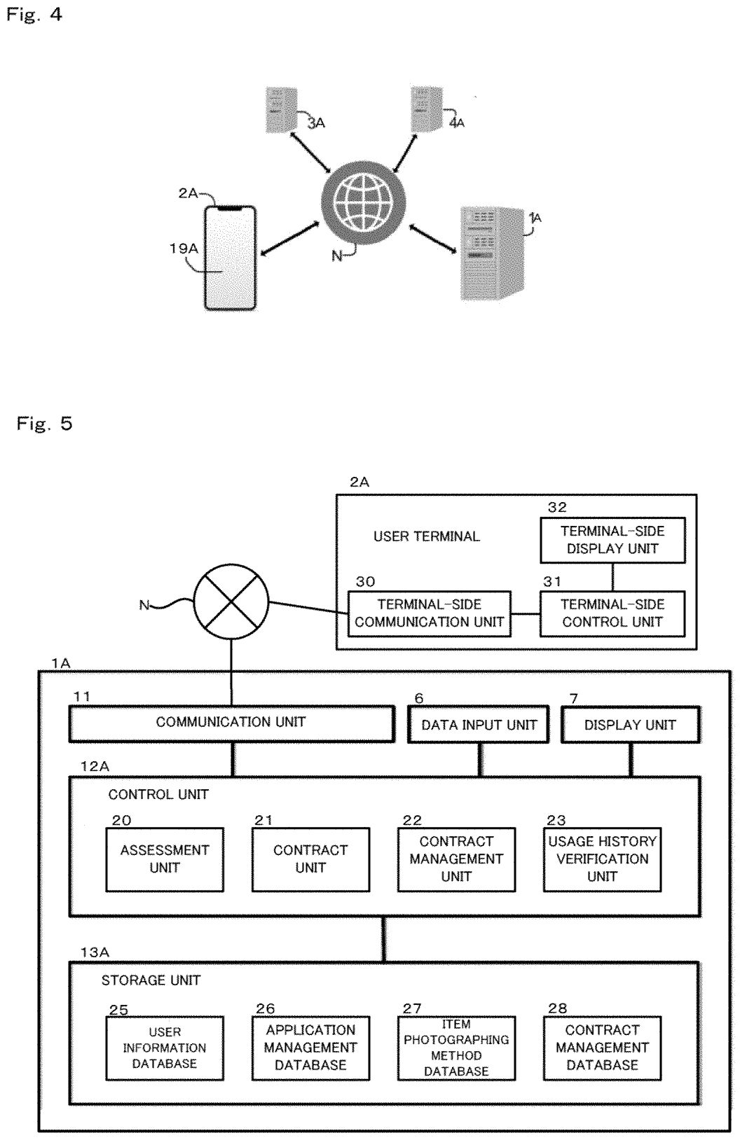

Next, a second embodiment will be described. Note that, in the following description of the second embodiment, the same reference numeral will be given to the same element as in the first embodiment, and detailed description thereof will be omitted. FIG. 4 is a view illustrating a configuration example of an information processing system 100A according to this embodiment, and FIG. 5 is a block diagram illustrating a functional configuration example of an information processing device 1A according to this embodiment. As illustrated in FIG. 4, the information processing system 100A includes the information processing device 1A, a user terminal 2A, a guarantee taking-over company's server device 3A, and a market price information DB device 4A, and the respective devices are connected to the network N.

As is apparent from comparison between FIG. 2 and FIG. 5, the information processing device 1A includes a control unit 12A instead of the control unit 12 relating to the first embodiment, and includes a storage unit 13A instead of the storage unit 13 relating to the first embodiment. The control unit 12A includes a processing device such as a CPU, a primary storage device such as a ROM, a secondary storage device such as a RAM, and other hardware. The control unit 12A executes various kinds of operation processing and information processing in cooperation of hardware and software. For example, the CPU reads out a program stored in the ROM into the RAM and executes the program. As illustrated in FIG. 5, the control unit 12A includes an assessment unit 20 instead of the assessment unit 12-1 relating to the first embodiment, includes a contract unit 21 instead of the contract unit 12-3 relating to the first embodiment, and includes a contract management unit 22 instead of the contract management unit 12-5 relating to the first embodiment. In addition, the control unit 12A includes a usage history verification unit 23. In addition, the storage unit 13A stores a user information database 25, an application management database 26, an item, photographing method database 27, and a contract management database 28. Respective pieces of data stored in the storage unit 13A will be described later.

As illustrated in FIG. 5, the user terminal 2A includes a terminal-side communication unit 30, a terminal-side control unit 31, and a terminal-side display unit 32. The terminal-side communication unit 30 communicates with a device connected to the network N in accordance with a protocol. The terminal-side control unit 31 includes a CPU, a ROM, a RAM, and the like, and executes various kinds of operation processing and information processing in cooperation of hardware and software. The terminal-side display unit 32 displays various images on a display device provided in the user terminal 2A or connected to the user terminal 2A under a control of the terminal-side control unit 31.

Here, the information processing device 1A provides a service (hereinafter, referred to as “this service”) to a user in cooperation with respective devices which constitute the information processing system 100A. That is, it is assumed that a user considers raising a large amount, of fund as soon as possible on the basis of a user's own item. The user sells the item to a service providing company who provides this service at a purchase price presented by the company and obtains the purchase price (raises a fund). On the other hand the user does not deliver the item to the service providing company and makes a lease contract relating to the item with the service providing company. According to this, following state is constructed. That is, the item remains in user's hand, the ownership of the item is transferred to the service providing company, and the item is leased to the user from the service providing company on the basis of the lease contract.

When making the lease contract, a schedule representing timing at which a lease charge is paid from the user to the service providing company, and the lease charge to be paid is presented from the service providing company to the user. Basically, the user pays the lease charge at each timing in accordance with the schedule. After completing payment of the lease charge, the user can terminate the lease contract by purchasing the item again by paying the remaining price, or can terminate the lease contract by returning the item to the service providing company (the user can take other actions, but the other actions will be described later). In addition, before completing payment of the lease charge, the user can terminate the lease contract by returning the item to the service providing company.

The information processing device 1A is configured to systemically realize the provision of this service described above in cooperation with respective devices which constitute the information processing system 100A. Furthermore, the information processing device 1A enables the user to easily use this service with a small burden by the following unique configuration. Hereinafter, operations of respective devices of the information processing system 100A will be described in the order of a service usage application scene, a contract scene, a contract management scene, and a usage history verification scene.

Note that, in the following description, it is assumed that the user terminal 2A is a smartphone provided with a camera function and a position detection function based on a GPS signal. As is well known, the smartphone is a tablet type terminal in which a touch panel 19A (FIG. 4) is provided in a wide region of a front surface, and can download a desired application by using an application download service. In addition, in the following description, a user who desires to use this service or is using this service is referred to as “target user”, and an item to be sold by the target user by using this service is referred to as “target item”. The target item corresponds to “object” in the appended claims.

<Service Usage Application Seene>

First, operations of respective devices of the information processing system 100A in the service usage application scene will be described. The service usage application scene is a scene until a purchase price of the target item is derived by the assessment unit 20 after the target user applies for usage of this service. In prior to application for usage of this service, the target user downloads an application (hereinafter, referred to as “dedicated application”) dedicated to the user terminal 2A. The dedicated application is an application that has at least a function of providing various screens (user interface) relating to this service. Furthermore, the target user performs member registration by using a screen provided by the dedicated application. From a result of the member registration, a user ID that is unique for every user is applied to the target user, and a record of the target user is registered in the user information database 25.

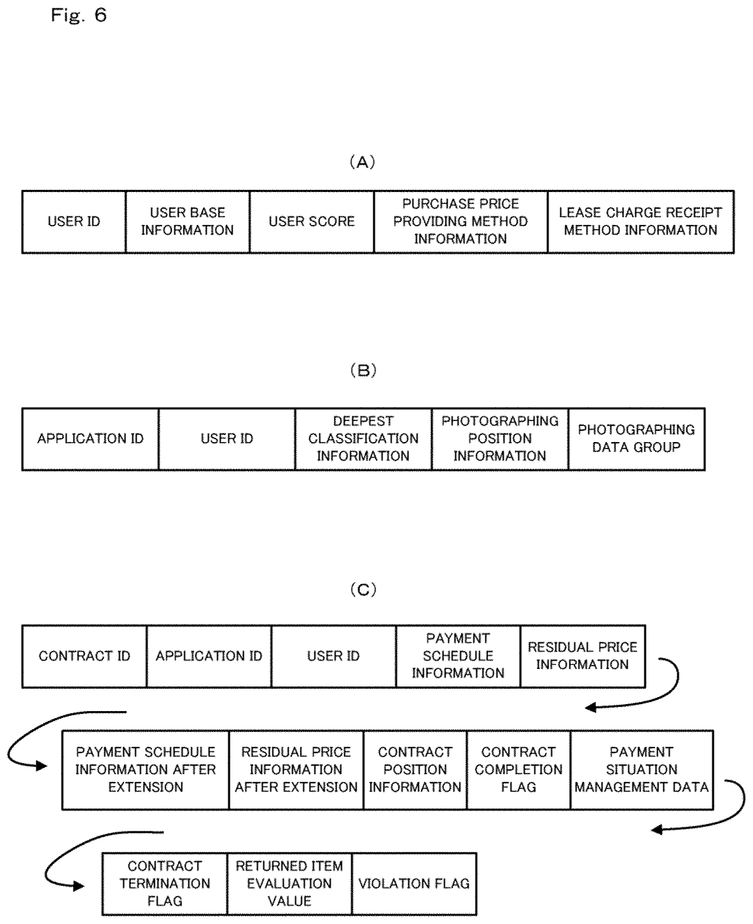

FIG. 6(A) is a view illustrating contents of one record of the user information database 25. As illustrated in FIG. 6(A), the one record of the user information database 25 includes a user ID, user base information, a user score, purchase price providing method information, and lease charge receipt method information. The user base information of an arbitrary user is information such as a telephone number, a mail address, and an address of the user which are necessary in member registration. Contents of the user score, the purchase price providing method information, and the lease charge receipt method information will be described later.

Note that, in this embodiment, the member registration is performed by using a dedicated application, but the member registration may be performed by performing various kinds of inputs to a webpage displayed when accessing a site of: a service providing company with a browser. In addition, timing at which member registration is performed is not necessary to be timing exemplified in this embodiment. For example, the member registration may be performed when a target user applies for a lease contract at first (application for the lease contract will be described later).

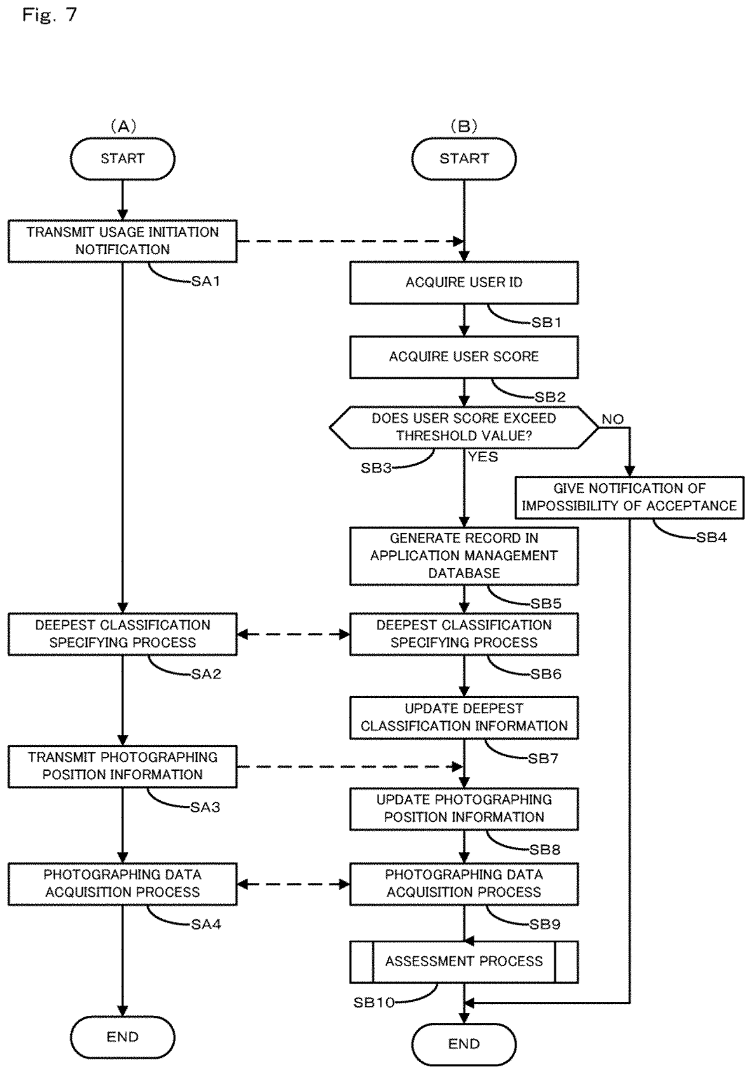

FIG. 7 is a flowchart illustrating operations of the information processing device 1A and the user terminal 2A in the service usage application scene. In FIG. 7, (A) illustrates an operation of the user terminal 2A and (B) illustrates an operation of the information processing device 1A. In application for usage of this service, the target user activates a dedicated application of the user terminal 2A. In accordance with activation of the dedicated application, the terminal-side control unit 31 of the user terminal 2A displays a home screen on a touch panel 19A. Note that in the following description, although not particularly described, in display of the screen on the touch panel 19A, the terminal-side control unit 31 obtains necessary information from a functional block of the information processing device 1A.

As illustrated in FIG. 7(A), the target user performs a predetermined operation, and gives an instruction for initiation of application for usage of this service on the home screen or a predetermined screen that transitions from the home screen. In accordance with the instruction, the terminal-side control unit 31 transmits a usage initiation notification including the user ID to the information processing device 1A (step SA1). Note that, although details will be omitted, communication between the user terminal 2A and the information processing device 1A is realized by an appropriate method conforming to a communication protocol after a connection corresponding to the communication protocol that is used is established. For example, the usage initiation notification in step SA1 is transmitted from the user terminal 2A to the information processing device 1A on TCP connection as HTTP request.

As illustrated in FIG. 7(B), the assessment unit 20 of the information processing device 1A receives the usage initiation notification, and acquires the user ID (step SB1). The assessment unit 20 specifies a record of the target user with reference to the user information database 25, and acquires a user score from the specified record (step SB2). A user score relating to a certain user is a score that lakes a large value as the probability of violation (described later) by the user is assumed to be lower on the basis of a usage history of this service for the user. As will be apparent later, the usage history verification unit 23 sets a value of the user score on the basis of the usage history of this service for each user.

Next, the assessment unit 20 determines whether or not the user score (=the user score of the target user) obtained in step SB2 exceeds a predetermined threshold value (step SB3). Note that, in a case where the user score is lower than the threshold value, this case represents that probability of violation of the user is considerably high in view of the usage history of the user, and thus the threshold value is set to be so. In a case where the user score does not exceed the threshold value (step SB3: NO), the assessment unit 20 communicates with the terminal-side control unit 31, and causes the touch panel 19A of the user terminal 2A to display the gist indicating that acceptance is impossible on (step SB4). In a case where the user score exceeds the threshold value (step SB3: YES), the assessment unit 20 generates a unique application ID for every application, and generates one record in the application management database 26 (step SB5).

FIG. 6(B) is a view illustrating contents of the one record of the application management database 26. The application management database 26 is a database that manages application performed by each user. As illustrated in FIG. 6(B), the one record of the application management database 26 includes an application ID, a user ID, deepest classification information, photographing position information, and a photographing data group. Hereinafter, application performed by the target user is referred to as “target application”. With regard to a target application record, the application ID is an application ID (application ID generated in step SB5) of the target application, and the user ID is a user ID of the target user. Contents of other information will be described later. The deepest classification information, the photographing position information, and the photographing data group are null values at this stage.

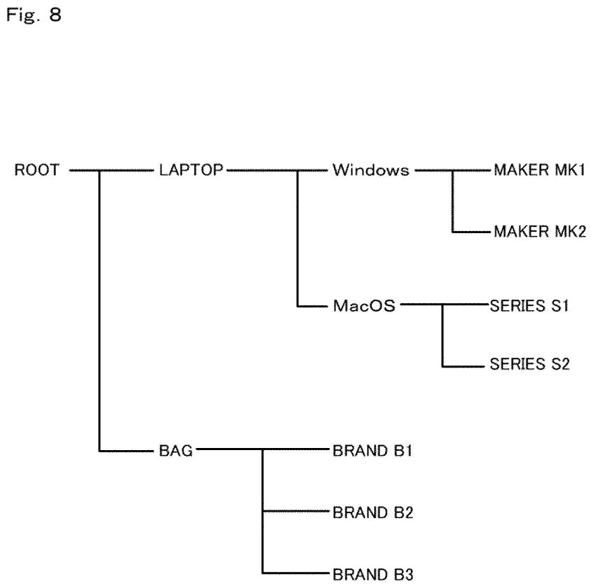

After processing in step SB5, the assessment unit 20 and the terminal-side control unit 31 executes deepest classification specifying process in cooperation with each other (step SA2, step SB6). Here, prior to description of the deepest classification specifying process, “item classification” and “deepest classification” in this embodiment will be described. In this embodiment, a tree of tree-structured item classification (hereinafter, referred to as “item classification tree”) is defined in advance for items to be purchased in this service. FIG. 8 is a view illustrating an example of the item classification tree. Hereinafter, the item classification tree will be described with reference to FIG. 8. However, the item classification tree exemplified in FIG. 8 is simplified for convenience of explanation. In the example illustrated in FIG. 8, two item classifications including a laptop (item classification) and a bag (item classification) are defined in one hierarchy below a root node to roughly classify items. In the following description, when expressing a hierarchy state of item classification, a root node exists as a matter of course, and thus the root node may be omitted. In addition, in this embodiment, it is assumed that the bag is a brand item.

In one level below hierarchy of the laptop (item classification), two item classifications including Windows (item classification) and MacOS (item classification) are defined with focus given to an OS (provided that, Windows and MacOS are registered trademarks). Furthermore, in one hierarchy below the laptop (item classification)>Windows (item classification), two item classifications including a maker MK1 (item classification) and a maker MK2 (item classification) are defined with focus given to a maker that sells a laptop of Windows. In addition, in one hierarchy below the laptop (item classification)>MacOS (item classification), two item classifications including a series S1 (item classification) and a series S2 (item classification) are defined with focus given to series of laptops of MacOS. In addition, in one hierarchy below the bag (item classification), three item classifications including a brand B1 (item classification), a brand B2 (item classification), and a brand B3 (item classification) are defined with focus given to a brand of the bag.

In the above-described example in FIG. 8, item classifications corresponding to a leaf node of the item classification tree correspond to the “deepest classification”. For example, “laptop (item classification)>Windows (item classification)>maker MK1 (item classification)” is one independent “deepest classification”, and “bag (item classification)>brand B3 (item classification)” is also one independent “deepest classification”. The deepest classification corresponds to “classification” in the appended claims. In addition, as will be clear from the above description, the “item classification” represents each classification when classifying a higher hierarchy into two or more in a certain hierarchy.

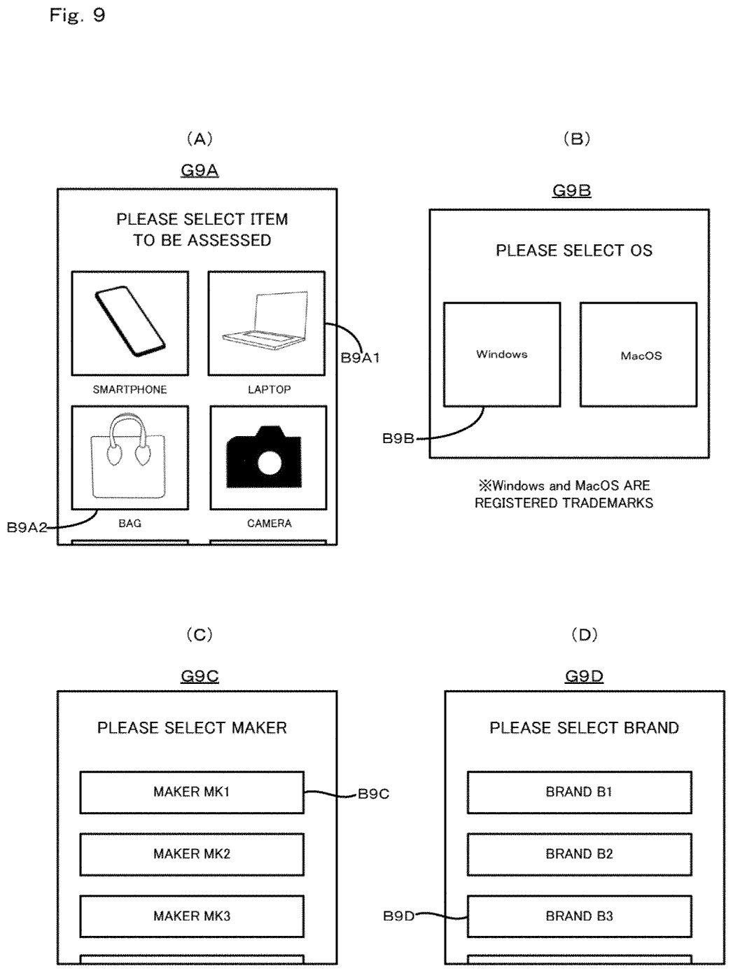

By the way, in the deepest classification specifying process, the assessment unit 20 causes the terminal-side control unit 31 to display a second layer item classification selection screen G9A (FIG. 9(A)) on the touch panel 19A of the user terminal 2A. FIG. 9(A) is an example of the second layer item classification selection screen G9A. The second layer item classification selection screen G9A is a screen on which an icon representing each item classification of a second layer are displayed in a list. The icon can be selected by a touch operation. The second layer item classification roughly classifies items to be purchased by this service, and sufficient kinds are prepared so that an item to be purchased in this service belongs to any one item classification. The target user selects an item classification by touching an icon corresponding to an item classification of a target item. The terminal-side control unit 31 notifies the assessment unit 20 of a selected item classification.

The assessment unit 20 causes the terminal-side control unit 31 to display a screen on which an icon indicating each item, classification of one hierarchy below a selected item classification (second layer item classification) is displayed in correspondence with the notification. The target user selects an item classification by touching any one icon. In this manner, when the target user selects an item classification on an arbitrary screen, a screen on which item classifications of one hierarchy below the selected item, classification are displayed in a list is displayed on the touch panel 19A, and the target user selects an item classification again. This process is repeated until the deepest classification is selected by the target user.

For example, it is assumed that a hierarchy structure of item, classification conforms to the item classification tree exemplified in FIG. 8, and the target item is a “laptop of which OS is Windows and a maker is the maker MK1”. In this case, with reference to FIG. 9, the target user selects an icon B9A1 indicating a laptop (item classification) on the second layer item classification selection screen G9A (FIG. 9(A)), a screen G9B (FIG. 9(B)) for selecting an item classification related to an OS is displayed in corresponding with the selection, the target user selects an icon B9B indicating Windows (item classification) on the screen G9B (in FIG. 9(B)), a screen G9C (FIG. 9(C)) for selecting an item classification related to a maker is displayed in correspondence with the selection, and the target user selects an icon B9C indicating the maker MK1 on the screen G9C (FIG. 9(C)). As described above, the deepest classification is selected by the target user. The deepest classification selected by the target user is given in notification from the terminal-side control unit 31 to the assessment unit 20.

In addition, for example, it is assumed that a hierarchy structure of an item classification conforms to the item classification tree exemplified in FIG. 8, and a target item is a “bag of which a brand is a brand B3”. In this case, with reference to FIG. 9, the target user selects an icon B9A2 indicating a bag (item classification) in the second layer item classification selection screen G9A (FIG. 9(A)), a screen G9D (FIG. 9(D)) for selecting an item classification related to a brand of the bag is displayed in correspondence with the selection, and the target user selects an icon B9D indicating a brand B3 (item classification) on the screen G94 (FIG. 9(D)). As described above, the deepest classification is selected by the target user. The deepest classification selected by the target user is given in notification from the terminal-side control unit 31 to the assessment unit 20.

The above-described process is the deepest classification specifying process performed by the assessment unit 20 and the terminal-side control unit 31, and the assessment unit 20 specifies the deepest classification of the target item by the deepest classification specifying process. The assessment unit 20 updates deepest classification information of the application management database 26 on the basis of the specified deepest classification (step SB7). Hereinafter, the deepest classification of the target item 13 referred to as “target deepest classification”. After execution of the deepest classification specifying process, the terminal-side control unit 31 acquires information (hereinafter, referred to as “photographing position information”) indicating a position (≈a current position of the target user) of the user terminal 2A at the current point of time by a position detection function of the user terminal 2A, and transmits the information to the information processing device 1A (step SA3). Note that, in step SA3, the terminal-side control unit 31 displays a predetermined dialog on the touch panel 19A to notify the target user of acquisition of a current position of the user terminal 2A by a dedicated application by using a position detection function, and obtains permission from the target user with respect to the acquisition. In addition, as will be clear later, in this embodiment, when a position where an item has been photographed, and a position where application for a contract has been performed are different from each other, a lease contract cannot be made. On the basis of this constraint, the terminal-side control unit. 31 may notify a user of the constraint under the control of the assessment unit 20.

As illustrated in FIG. 7(B), the assessment unit 20 acquires the photographing position information, and updates a value of the photographing position information of the application management database 26 (step SB8). Next, the assessment unit 20 and the terminal-side control unit 31 execute a photographing data acquisition process in cooperation with each other (step SA4, step SB9). Hereinafter, the photographing data acquisition process will be described in detail. Here, as described above, in this embodiment, the deepest classification is defined in conformity to the item classification tree, and an item belongs to any one deepest classification. In addition, in this embodiment, whether photographing data photographed by which method is necessary is determined in advance for every deepest classification. Hereinafter, a method when photographing an item is referred to as “item photographing method”. A plurality of item photographing methods determined for one deepest classification may exist (in this embodiment, basically, a plurality of methods exist due to the following reason).

As will be clear later, the photographing data is used when deriving a purchase price of an item. In addition, one or more item photographing methods related to a certain deepest classification are determined from the viewpoint of preparing data of contents appropriate as photographed image data that is used when deriving a purchase price of an item belonging to the deepest classification. Particularly, in this embodiment, the item photographing method is determined in consideration of the following four viewpoints. Note that, in the following description, derivation of the purchase price may be appropriately expressed as “assessment”.

Viewpoint P1: An external appearance of an item is set to be photographed.

Viewpoint P2: Photographing is set to photograph a site where a deterioration that is an appearance deterioration such as scratches, dirt, wear, depressions, and defects of parts, and that affects assessment may appear or is likely to appear.

Viewpoint P3: With regard to a device capable of displaying system information (a device on which a certain OS is mounted is assumed), system information displayed on a display unit (for example, a touch panel in a tablet terminal or a display panel in a laptop. The display unit may be a connected external display device) is set to be photographed. Note that, the system information is information in which various specification or various statuses of a device such as an OS name, an OS version, a processor type, and a model number (model) of a computer are shown in a list.

Viewpoint P4: In a case where authenticity determination target that can be used in authenticity determination by image processing is included in an item, the authenticity determination target is set to be photographed. Note that, the authenticity determination target is, for example, a logo, a pattern, a mark, a specific planar or three-dimensional shape, or the like which is attached to the item, and the entirety of the item (for example, a three-dimensional shape of the entirety of the item) instead of a part of the item may be a target of the authenticity determination.

Hereinafter, an attribute of photographing data generated by photographing based on the viewpoint P1 is referred to as “external appearance photographing data”, an attribute of photographing data generated by photographing based on the viewpoint P2 is referred to as “photographing data for state determination”, an attribute of photographing data generated by photographing based on the viewpoint P3 is referred to as “system information photographing data”, and an attribute of photographing data generated by photographing based on the viewpoint P4 is referred to as “photographing data for authenticity determination”. One piece of photographing data may have a plurality of attributes. As an example, attributes of one sheet of photographing data may be “external appearance photographing data” and “photographing data for state determination”.

By the way, in the photographing data acquisition process, a photographing procedure is appropriately guided to the target user so that an item is photographed in an item photographing method corresponding to the deepest classification, photographing is performed by the target user in accordance with the guide, and generated photographing data is acquired by the assessment unit 20. Hereinafter, an example of operations of the assessment unit 20 and the terminal-side control unit 31 in the photographing data acquisition process will be described on the assumption that the target deepest classification is “laptop (item classification)>Windows (item classification)>maker MK1 (item classification)”. Note that, in a case where the deepest classification is “laptop (item classification)>Windows (item classification)>maker HK1 (item classification)”, with regard to the item photographing method, it is assumed that external appearance photographing data, photographing data for state determination, and system information photographing data are determined to be generated.

First, the assessment unit 20 acquires data related to the item photographing method corresponding to the target deepest classification with reference to the item photographing method database 27 stored in the storage unit 13A. The item photographing method database 27 is a database in which item photographing method related data is registered for every deepest classification. The item photographing method related data includes drawing data (an HTML file, data for generating the HTML file, or the like) of various screens displayed in the terminal-aide control unit 31 by the assessment unit 20 in a photographing data acquisition process. In the following photographing data acquisition process to be described below, a process in the assessment unit 20 is executed on the basis of data related to item photographing method corresponding to the target deepest classification.

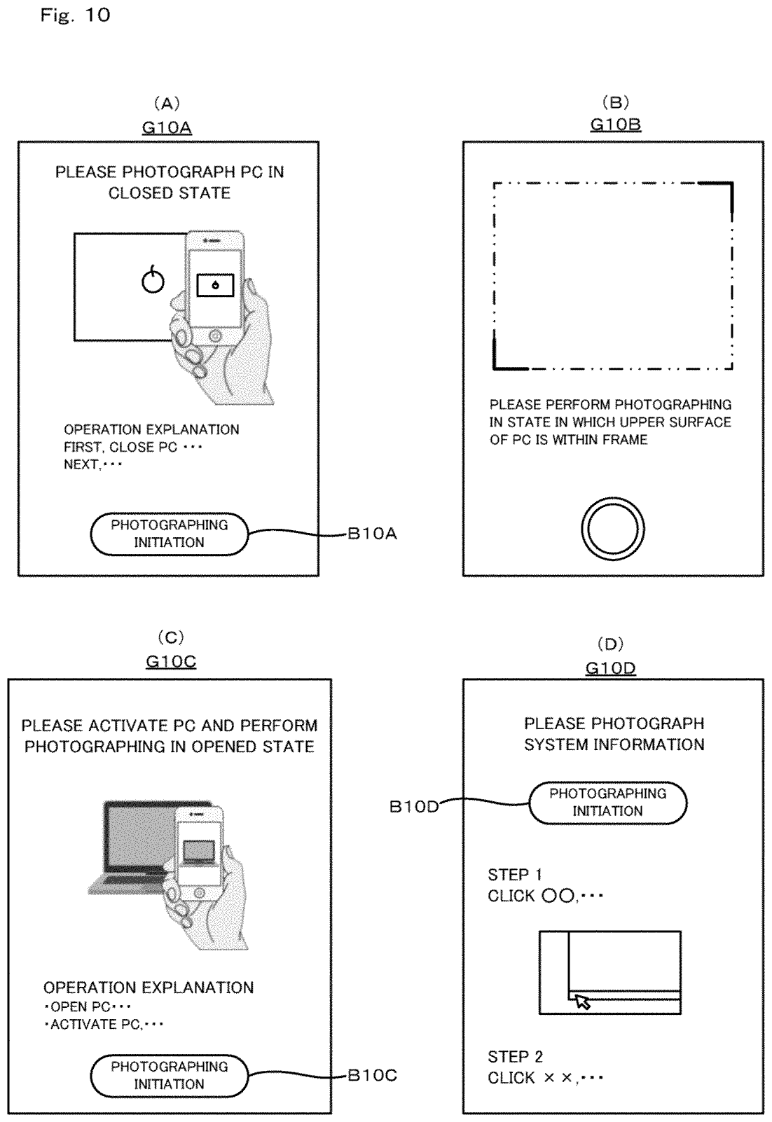

The assessment unit 20 causes the terminal-side control unit 31 to display a screen GIGA in FIG. 10(A). On the screen G10A in FIG. 10(A), a sentence that gives an instruction for photographing of an upper surface of the laptop in a closed state is displayed in combination with an illustration in which a state of photographing a laptop in a closed state is drawn. In addition, a button B10A that gives an instruction for initiation of photographing is displayed on the screen in FIG. 10(A), and the target user operates the button B10A when photographing is prepared. In correspondence with operation of the button 10A, the terminal-side control unit 31 validates a camera function of the user terminal 2A by using an API provided by an OS, and displays a screen G10B in FIG. 10(B) on the touch panel 19A in cooperation with the assessment unit 20. In the screen G10B in FIG. 10(B), a frame line and a sentence that gives an instruction for photographing in a state in which an upper surface of the laptop as the target item is within the frame line are displayed on a photographing image by a camera of the user terminal 2A in an overlapping manner. The target user performs photographing in a state in which the screen G10B in FIG. 10(B) is displayed, and photographing data is generated in correspondence with photographing. Attributes of the photographing data generated here are “external appearance photographing data” and “photographing data for state determination”.

When photographing is performed in a state in which the screen in FIG. 10(B) is displayed, the terminal-side control unit 31 displays a screen G10C in FIG. 10(C) on the touch panel 19A in cooperation with the assessment unit 20. On the screen G10C in FIG. 10(C), a sentence that gives an instruction for photographing in a state in which the laptop is opened and the laptop is activated is displayed in combination with an illustration in which a state of photographing the laptop in an opened state is drawn. In addition, a button B10C that gives an instruction for initiation of photographing is displayed on the screen in FIG. 10(C), and the target user operates the button B10C when photographing is prepared. In correspondence with an operation of the button B10C, the terminal-side control unit 31 validates the camera function of the user terminal 2A, and displays a screen, on which a frame line and precautions at the time of photographing are displayed, on a photographing image as in FIG. 10(B) in cooperation with the assessment unit 20. The target user performs photographing in a state in which the screen is displayed, and photographing data is generated in correspondence with photographing. Attributes of photographing data generated here are “external appearance photographing data” and “photographing data for state determination”.

When photographing is performed by the target user, the terminal-side control unit 31 displays a screen G10D in FIG. 10(D) on the touch panel 19A in cooperation with the assessment unit 20. A procedure for displaying system, information on a display unit of a laptop is displayed on the screen G10D in FIG. 10(D) (provided that, in FIG. 10(D), contents are simplified). In addition, a button B10D that gives an instruction for initiation of photographing is displayed on the screen G10D in FIG. 10(D), and in accordance with the procedure displayed on the screen G10D in FIG. 10(D), the target user sets system, information to be displayed on the display unit of the laptop, and touches the button B10D when being ready to photograph. In correspondence with touching of the button B10D, the terminal-side control unit 31 validates the camera function of the user terminal 2A, and displays a screen on which a frame line and precautions at the time of photographing on a photographing image are displayed as in FIG. 10(B) in cooperation with the assessment unit 20. The target user performs photographing in a state in which the screen is displayed, and photographing data is generated in correspondence with photographing. An attribute of photographing data generated here is “system information photographing data”.

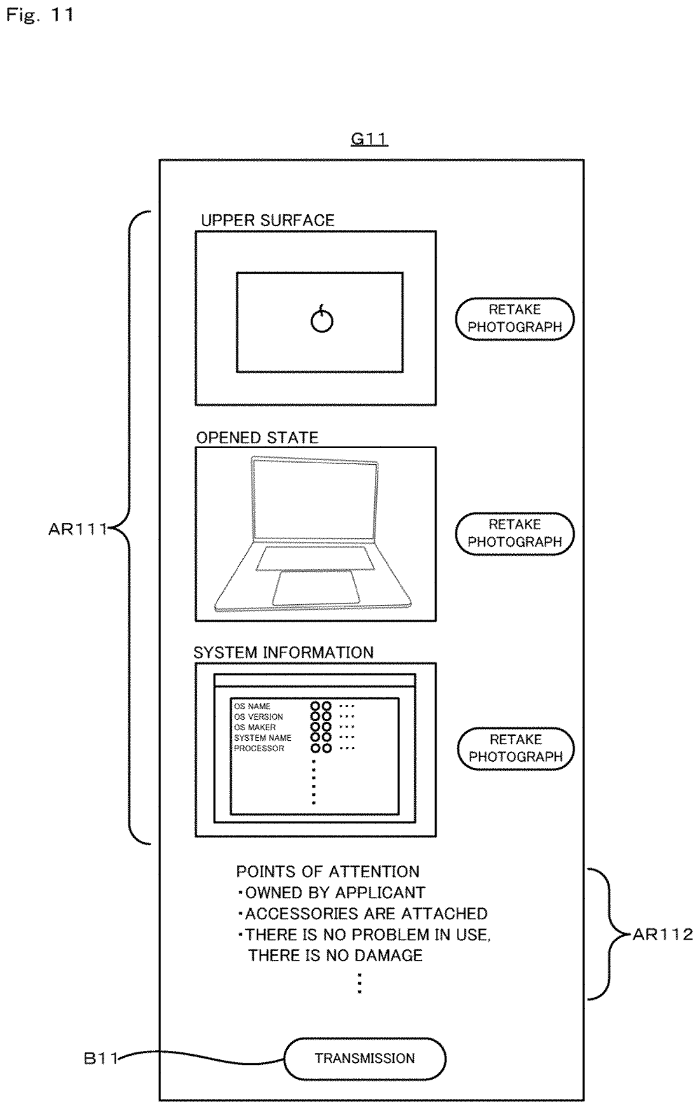

When photographing is performed by the target user, the assessment unit 20 causes the terminal-side control unit 31 to display a confirmation screen G11 in FIG. 11 on the touch panel 19A. As illustrated in FIG. 11, three photographing images based on three pieces of photographing data generated by photographing are displayed on the confirmation screen G11 (refer to region AR111). Note that, the target user can retake a photograph with respect to arbitrary photographing data. In addition, points of attention at the time of proceeding application for contract are displayed on the confirmation screen G11 (refer to region AR112). The points of attention include information indicating that a photographed item is owned by the target user, or information of the gist indicating that appropriateness of a state of the item should be confirmed. In addition, a transmission instruction button B11 for giving an instruction of transmission of photographing data is displayed on the confirmation screen G11. In correspondence with an operation of the transmission instruction button B11, a notification including three pieces of photographing data are transmitted from the terminal-side control unit 31 to the assessment unit 20, and the assessment unit 20 receives the notification, acquires the three pieces of photographing data, and stores the three pieces of photographing data as a photographing data, group in a target application record of the application management database 26. That is, a photographing data group is information including one or more pieces of photographing data generated on the basis of photographing of the user.

Hereinbefore, description has been given of an example of the operations of the assessment unit 20 and the terminal-side control unit 31 in the photographing data acquisition process in a case where the target deepest classification is “laptop item classification)>Windows item classification)>maker MK1 (item classification)”, but in the photographing data acquisition process the target user is appropriately guided in correspondence with the target, deepest classification so that photographing data having contents corresponding to the target deepest classification is generated. That is, the assessment unit 20 causes the user terminal 2A to display a screen indicating a photographing method corresponding to the deepest classification (object classification) of the target item. For example it is assumed that the deepest classification is “bag (item classification)>brand B3 (item, classification)”. In addition it is assumed that as a method of photographing an item of the deepest classification the following four methods are determined. The methods include a first method of photographing the entire region of one surface of the bag, a second method of photographing the entire region of another surface of the bag a third method of photographing the inside in a state in which the bag is opened and a fourth method of photographing by enlarging a logo attached to a predetermined position of one surface of the bag. The first to third methods are based on the viewpoint P1 and the viewpoint P2 and the fourth method is based on the viewpoint P4. In this case in the photographing data acquisition process, the assessment unit 20 and the terminal-side control unit 31 appropriately guide the target user by displaying a screen showing a photographing method corresponding to the object classification on the user terminal 2A so that photographing is performed by each of the first to fourth methods.

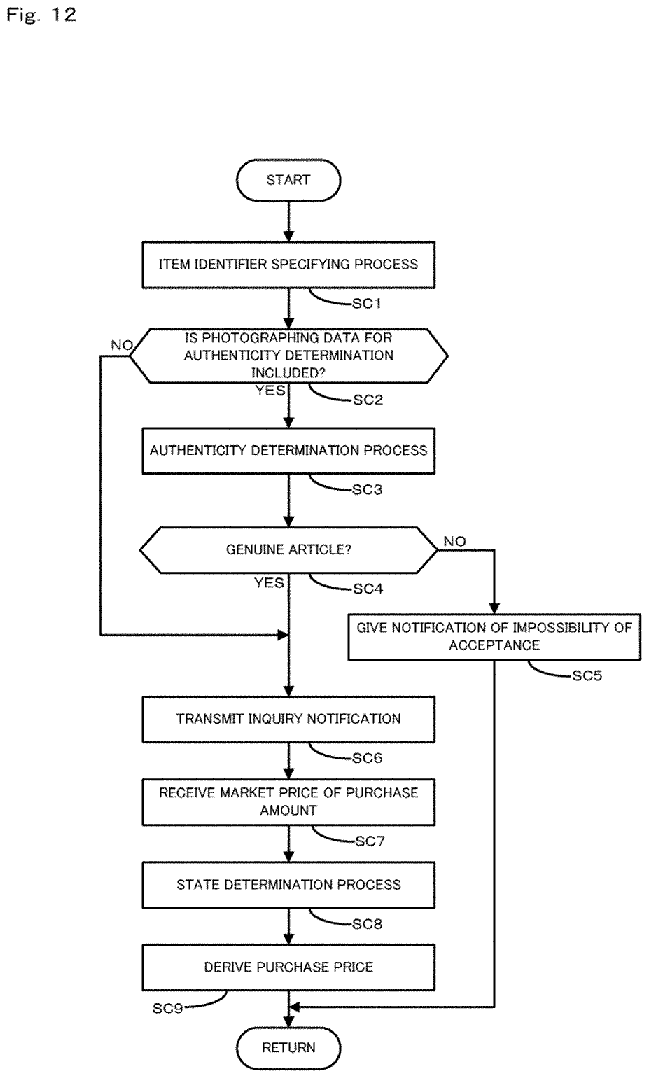

The above-described process is the photographing data acquisition process executed by the assessment unit 20 and the terminal-Side control unit 31. As a result of execution of the photographing data acquisition process, it enters a state in which one or more pieces of photographing data are included in the photographing data group of the target application record of the application management database 26. After execution of the photographing data acquisition process, the assessment unit 20 executes an assessment process (step SB10). FIG. 12 is a flowchart illustrating details of the assessment process.

As illustrated in FIG. 12, the assessment unit 20 executes an item identifier specifying process (step SC1). Here, the market price information DB device 4A includes a database in which an item identifier and a market price for a purchase amount are registered in association with each other with respect to various items. In this embodiment, the market price for the purchase amount with respect to a certain item represents a general market price for the amount of money when purchasing an item at a market where a used item is purchased. Note that, the term “purchase amount” is used for distinguishment from the “purchase price” that is derived by the assessment unit 20. That is, the item identifier is identification information that becomes a minimum unit in which the market price of the purchase amount is managed in the market price information DB device 4A. As an example, for example, with regard to a bag, a model number corresponds to the item, identifier, and with regard to a laptop and other electronic appliances, a model number (may be referred to as a device type and a model) corresponds to the item identifier (this is illustrative only, and another information may be the item, identifier with regard to the bag or the laptop). In this embodiment, the assessment unit 20 specifies an item identifier of a target item by image processing with respect to one or more pieces of photographing data included in the photographing data group in an item identifier specifying process.

Hereinafter, description will be given of an example of the item identifier specifying process by the assessment unit 20 on the assumption that the target item is a bag, and a model number of the bag corresponds to the item identifier. First, the assessment unit 20 recognizes that the item is a bag and a brand of the bag on the basis of the deepest classification information (=information indicating the deepest classification of the target item) of a record of target application in the application management database 26 (it is assumed that the deepest classification related to the bag includes at least an item classification related to the brand). Here, the storage unit 13A stores a database in which template data for every model number is registered with respect to each brand of the bag. With respect to external appearance photographing data included in the photographing data group, the assessment unit 20 specifies the model number by performing template matching using each template data corresponding to the brand of the target item.

Note that, the template matching is appropriately executed on the basis of an existing technology (for example, template matching using template data that retains a pixel value, chamfer matching, active search using histogram information) after performing pre-processing including removal of noise, or correction of a size and an angle for external appearance photographing data (provided that, correction of the size and the angle may be performed with respect to template data). However, a method of specifying the model number by using the external appearance photographing data is not limited to the exemplified method. For example, a method of using feature matching, or a combination of the template matching and the feature matching may be used. In addition, for example, the method may also be performed by using a model in which the external appearance photographing data is set as one input and a corresponding model number (or possibility corresponding to each model number) is set as an output. In this case, the model can be set as a model that is machine-learned by a predetermined machine learning method (for example, a model that is machine-learned by deep learning).

Next, an example of the item identifier specifying process by the assessment unit 20 will be described on the assumption that the target item is a laptop and a model number of the laptop corresponds to the item identifier. The assessment unit 20 recognizes that an item is a laptop on the basis of the deepest classification information (=information indicating the deepest classification of the target item) of a record of the target application in the application management database 26. Next, the assessment unit 20 performs optical character recognition (image processing) with respect to system information photographing data included in the photographing data group and specifies a portion of a character string indicating a model number to specify the model number. The process corresponds to analysis by image processing for photographing data. For example, first, the assessment unit 20 specifies a character string (for example, a system model, a model, a device type, or the like) that is used as an item of the model number on the basis of the fact in which combinations of an item and an item value are basically arranged in parallel in system information, and specifies an item value that is associated with a specific character string as the model number.

After specifying the item identifier by the item identifier specifying process, the assessment unit 20 determines whether or not photographing data for authenticity determination is included in the photographing data group (step SC2). Note that, whether or not the photographing data for authenticity determination is included in the photographing data group is determined by the kind of the deepest classification. In a case where the photographing data for authenticity determination is not included (step SC2: NO), the assessment unit 20 transitions the procedure to step SC6. On the other hand, in a case where the photographing data for authenticity determination is included in the photographing data group (step SC2: YES), the assessment unit 20 executes an authenticity determination process (step SC3).

The authenticity determination process is a process of determining whether or not the target item is a genuine item (a regular product) through image processing. The authenticity determination process corresponds to analysis through image processing with respect to one or more pieces of photographing data. In the authenticity determination process in step SC3, the assessment unit 20 determines whether or not the target item is genuine through image processing based on photographing data for authenticity determination. Hereinafter, it is assumed that the target item is a bag, and the photographing data for authenticity determination is photographing data generated by photographing a logo attached to a predetermined position of the bag. In this case, the assessment unit 20 analyzes the photographing data for authenticity determination from the viewpoint that the logo recorded as an image on the photographing data for authenticity determination is genuine as a logo of the bag having a model number (=a model number of the target item) specified in step SC1, and determines whether or not the target item, is genuine. Analysis of the photographing data for authenticity determination is executed from various viewpoints. For example, analysis of the photographing data for authenticity determination is performed by determining by validity of a shape of the logo, validity of a color of the logo, validity of a position of the logo, and the like.

Note that, the validity of the position of the logo represents whether or not the position where the log is attached matches a position of a genuine item. In a case where the validity of the position of the logo is determined, a user is guided at the time of photographing an item so that the item is to be photographed in a state in which a relative position and a relative size of the logo with respect to the entirety of the item can be determined. For example, determination of the validity of the shape and position of the logo can be performed by pattern matching or feature matching that uses template data corresponding to a genuine logo that is prepared in advance. In addition, determination of the validity of: the color of the logo can be performed, for example, by analysis of a histogram of color components or analysis of a distribution of respective color components in an image. Note that, with regard to determination as to whether or not the target item is genuine on the basis of analysis of the photographing data for authenticity determination, as an actual process, for example, a model in which the photographing data for authenticity determination is set as one input and which outputs information indicating whether or not an item is genuine (or information indicating possibility that the item is genuine) is prepared, and the determination is performed by using the model. In this case, the model can be set as a model that is machine learned by a predetermined machine learning method (for example, deep learning).

Hereinbefore, description has been given of the authenticity determination process in a case where the item is a bag and the photographing data for authenticity determination is photographing data including an image of a log attached to a predetermined position of the bag, but in the authenticity determination process, the photographing data for authenticity determination is analyzed by image processing by an appropriate method corresponding to an item and an authenticity determination target, and determines whether or not an item is genuine.

After executing the authenticity determination process, the assessment, unit 20 determines whether or not the target item is a genuine item in the authenticity determination process (step SC4). In a case where it is determined as not a genuine item (step SC4: NO), the assessment unit 20 communicates with the terminal-side control unit 31 and causes the touch panel 19A of the user terminal 2A to display the gist indicating that acceptance is impossible (step SC5). That is, in a case where the target item is not a genuine item from the result in authenticity determination, the assessment unit 20 does not derive the purchase price and executes a corresponding process. On the other hand, in a case where it is determined as a genuine item (step SC4: YES), the assessment unit 20 transmits an inquiry notification including an item identifier to the market price information DB device 4A (step SC6).

The inquiry notification is a notification that inquires a market price of a purchase amount of an item which is indicated by the item identifier. Note that, in the inquiry notification, information transmitted from the assessment unit 20 to the market price information DB device 4A is not limited to an item identifier. For example, in a case where transmission of a photographing image data group (or one or more pieces of photographing data included in the photographing image data group) is requested, the photographing image data group is also transmitted. In addition, for example, in a case where transmission of predetermined information (for example, information on a processor, information on a storage device, or the like) obtained by optical character recognition with respect to system information photographing data is requested, the predetermined information is also transmitted.

The market price information DB device 4A recognizes a market price of a purchase amount of an item indicated by an item identifier included in the inquiry notification with reference to a corresponding database in correspondence with reception of the inquiry notification. Then, the market price information DB device 4A transmits the market price of the purchase amount that is recognized to the assessment unit 20. The assessment unit 20 receives the market price of the purchase amount that is transmitted by the market price information DB device 4A (step SC7). Then, the assessment unit 20 executes a state determination process (step SC8). Hereinafter, the state determination process will be described in detail. In the state determination process, the assessment unit 20 acquires photographing data for state determination from the photographing data group. Then, the assessment unit 20 executes an external appearance inspection, process through image processing with respect to the acquired photographing data for state determination, and detects an item state level (corresponding to “degree of deterioration” in the appended claims).

The item state level is a level indicating that an item, is in a state close to a new item to a certain extent (deterioration is small to a certain extent) in consideration of a situation of deterioration-related elements such as scratches, dirt, depressions, wear, and detects of parts. As a value of an item state level, five values from a level L5 indicating a state closest to a new item (state in which deterioration is smallest) to a level L1 indicating a state farthest from the new item (state in which deterioration is largest) are prepared. The assessment unit 20 derives the item state level by reflecting the situations of the deterioration-related elements such as scratches, dirt, depressions, wear, and defects of parts by using an existing image processing algorithm related to an external inspection process. Data necessary for execution of the state determination process is prepared in advance. For example, data necessary for execution of the state determination process is template data for every model number in a case of executing pattern matching using template data corresponding to a model number of an item. In addition, at least a part of process in the state determination process may be configured to be performed by using a machine-learned model. Note that, the state determination process corresponds to analysis by image processing with respect to one or more pieces of photographing data.

After executing the state determination process, the assessment unit 20 derives a price obtained by multiplying the market price of the purchase amount that is received from the market price information DB device 4A in step SC7 by a coefficient corresponding to the item state level as a purchase price (step SC9). The coefficient corresponding to the item state level is a coefficient that is adjusted so that as the item state level is higher (as deterioration of the target, item is smaller and it is closer to a new item), the coefficient become large, and as the item state level is low (as deterioration of the target item is larger and it is farther from a new item), the coefficient becomes small. When the purchase price is derived by multiplying the market price of the purchase amount by the coefficient corresponding to the item state level, it is possible to set the purchase price to a value that is based on the state of the target item and is close to a substantial value of the target item.

Note that, a method of deriving the purchase price by reflecting the item state level is not limited to the method exemplified in this embodiment. In addition, an index indicating the degree of deterioration of an item may be set to, for example, a score without limitation to the item state level (five-stage level).

Modification Example of Operation of Each Device in Service Usage Application Scene>

Next, description will be given of a modification example of operations of respective devices in a service usage application scene. In this embodiment, the purchase price is derived by information processing in the assessment unit 20 which is based on the photographing data group and other pieces of information. That is, the assessment unit 20 derives and acquires the purchase price. With regard to this point, a person, in charge in a service providing company, and other persons may derive the purchase price by performing assessment on the basis of information (in this embodiment, the photographing data group or the deepest classification information) acquired by the assessment unit 20 through a network, may input the information to the information processing device 1A through a data input unit (additional means may be employed), and the assessment unit 20 may acquire the information. This configuration corresponds to a configuration of “assessment unit that acquires information on an object owned by a user through a network, and acquires a purchase price based on the acquired information on the object at the time of purchasing the object” in the appended claims.

In addition, as the information on the object owned by the user, the information that is acquired by the assessment unit 20 through the network N is not limited to the photographing data and may be, for example, text data in which information necessary for assessment of the target item is recorded as a character string. That is, the “information on the object owned by the user” which is acquired by the assessment unit 20 through the network N may be information necessary for operation processing/information processing in a case where the assessment unit 20 derives the purchase price by the operation processing/information processing, and may be information necessary for a human being in a case where the human being derives the purchase price.

In addition, in this embodiment, the assessment unit 20 is configured to analyze photographing data to specify the item identifier, but the item identifier may be input by a user. However, the user may not grasp the item identifier in many cases, and a work of investing the item, identifier and accurately inputting the item identifier may be difficult, and thus this embodiment has an advantage in that a burden on the user is small.

In addition, in this embodiment, the assessment unit 20 is configured to analyze the photographing data to specify the item state level, but the item state level may be input by a user. However, in a case of inputting the item state level by the user, the state of the item is determined by the user's subjectivity, and thus there is a case where an individual difference may occur in evaluation (even in the completely same item, the item may be set to a different item state level by the user), and thus this embodiment has an advantage in this point.

In addition, in this embodiment, the deepest classification is designated by the user. In this regard, the following configuration may be employed. Specifically, the assessment unit 20 guides the target user to photograph the entirety of the target item (or a part having a characteristic), and photographing data photographed in this manner is acquired. Then, the assessment unit 2C analyzes the acquired photographing data and specifies the deepest classification of the target item. Then, the assessment unit 20 guides the target user so that photographing is performed in accordance with an item photographing method corresponding to the deepest classification. The above-described configuration may be employed.

In addition, in this embodiment, the assessment unit 20 transmits the item identifier of the target item to the market price information DB device 4A, acquires the market price of the purchase amount of the target item from the market price information DB device 4A, corrects the market price on the basis of the item state level, and drives the purchase price. In this regard, the following configuration may be employed. Specifically, the assessment unit 20 transmits the item state level to the market price information DB device 4A in combination with the item identifier. The market price information DB device 4A specifies the market price of the purchase amount that corresponds to the item identifier in addition to the item state level, and transmits the market price to the assessment unit 20. The assessment unit 20 acquires the received market price (derived after reflecting the item state level in the market price information DB device 4A) of the purchase amount as the purchase price.

In addition, with regard to an item for which system information photographing data is acquired, the assessment unit 20 may be configured to derive the purchase price by reflecting information obtained by subjecting the data to optical character recognition (image processing). For example with regard to constituent elements of a device such as a processor and a storage device, if there is a point that can be evaluated while increasing the value of the target item (or a point that decreases the value), the purchase price may be adjusted by reflecting the point.

In addition, in this embodiment, the authenticity determination of the large item is performed by an authenticity determination process by the assessment unit (analysis through image processing with respect to one or more pieces of photographing data). In this regard, a final authenticity determination may be performed by a human being (for example, a person in charge in a service providing company) on the basis of a result (analysis result) in the authenticity determination process by the assessment unit. In this configuration, the assessment unit may be configured to output information indicating a possibility of genuine item as a result of the analysis by the image processing. According to this configuration, accuracy of the authenticity determination can be improved, and an artificial burden related to the authenticity determination can be reduced.

In addition, in this embodiment, the state determination of the target item is performed by the state determination process (analysis through image processing with respect to one or more pieces of photographing data) by the assessment unit. In this regard, a human being may perform a final state determination on the basis of a result (analysis result) of the state determination process by the assessment unit. According to this configuration, accuracy of the state determination can be improved, and a human burden related to the state determination can be reduced. Note that, the procedure in the service usage application scene is not limited to the procedure exemplified in this embodiment. This is also true of other scenes.

<Contract Scene>

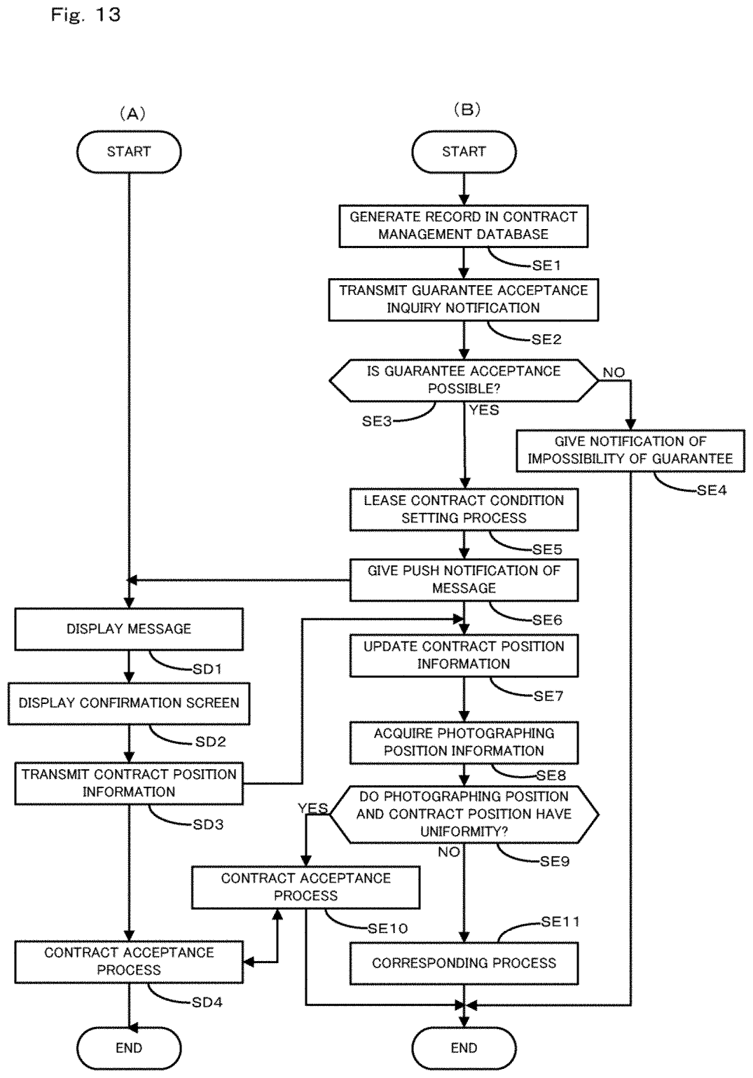

Next, operations of respective devices of the information processing system 100A in a contract scene will be described. The contract scene is a scene until a lease contract is made between the target user and the service providing company on the basis of the purchase price after the purchase price is derived. FIG. 13 is a flowchart illustrating operations of the user terminal 2A and the information processing device 1A in the contract scene, and (A) illustrates the operation of the user terminal 2A and (B) illustrates the operation of the information processing device 1A.

As illustrated in FIG. 13(B), the contract unit 21 of the information processing device 1A issues a contract ID that is a unique value for every contract, and generates one record in the contract management database 28 (step SE1) FIG. 6(C) illustrates contents of the one record of the contract management database 28. Hereinafter, a contract made between the target user and the service providing company is referred to as “target contract”. As illustrated in FIG. 6(C), the one record of the contract management database 28 includes a contract ID, an application ID, a user ID, payment schedule information, residual price information, payment schedule information after extension, residual price information after extension, contract position information, a contract completion flag, payment situation management data, a contract termination flag, a returned item evaluation value, and a violation flag. Contents of respective pieces of information will be described later. The payment schedule information, the residual price information, the payment schedule information after extension, the residual price information after extension, the contract position information, and the returned item evaluation price are null values at the present stage. In addition, the contract completion flag, the contract termination flag, and the violation flag are turned off at the present stage.

Next, the contract unit 21 transmits information indicating a purchase price acquired by the assessment unit 20, information on the target user, the photographing data group, and a guarantee acceptance inquiry notification including an item identifier of the target item to the guarantee taking-over company's server device 3 (step SE2). Note that, the kind of the information included in the guarantee acceptance inquiry notification and the contents of the information are determined on the basis of agreement with a guarantee taking-over company, and is not limited exemplification in this embodiment. For example, in a case where the guarantee taking-over company does not need the item identifier of the target item, the information cannot be included in the guarantee acceptance inquiry notification. In addition, the information on a user is set as information necessary for the guarantee taking-over company to recognise the user, and as an example thereof, the information is set as a record (partial information of the record) of the target user in the user information database 25.

The guarantee taking-over company's server device 3 that receives the guarantee acceptance inquiry notification determines whether or not the guarantee company can take over the guarantee. This determination may be performed in a state of including an artificial behavior. The guarantee taking-over company's server device 3 transmits information indicating a determination result to the contract unit 21. The contract unit 21 receives the information, and determines whether or not guarantee taking-over by the guarantee company is possible on the basis of the information (step SE3). In a case where it is determined that the guarantee taking-over by the guarantee company is impossible (step SE3: NO), the contract unit 21 communicates with the terminal-side control unit 31 and causes the touch panel 19A of the user terminal 2A to display the gist indicating that acceptance is impossible (step SE4). In a case where it is determined that guarantee taking-over by the guarantee company is possible (step SE3: YES), the contract unit 21 executes a lease contract condition setting process (step SE5). Hereinafter, details of the lease contract condition setting process will be described.

In the lease contract condition setting process, one or more times of payment dates at which a lease charge is to be paid, and the lease charge to be paid at each payment date are set. Hereinafter, the lease charge that is paid at the payment date is particularly referred to as “paid lease charge”. In addition, a combination of each of the payment dates in a case where the lease contract is not extended, and the lease charge to be paid at each of the payment dates is referred to as “payment schedule”. For example, the payment schedule represents that a usage charge on Jan. 1, 2020: 5,000 Yen, a usage charge on Feb. 1, 2020: 5,000 Yen, and a usage charge on Mar. 1, 2020: 5,000 Yen.

In this embodiment, a model, to which at least a lease charge (hereinafter, referred to as “total lease charge”) obtained by multiplying the purchase price by a predetermined lease charge rate, a model number, and an item state level are input and which outputs the payment schedule, is prepared in advance. The model is designed to set scheduling and a payment lease charge by reflecting a total lease charge, the model number, and the item state level, and to output the payment schedule. The contract unit 21 inputs the total lease charge, the model number, and the item, state level to the model, and obtains an output of the model, thereby setting the payment schedule. In addition, in the lease contract condition setting process, a residual price of the target item, when the payment schedule is completed is set. The contract unit 21 sets the residual price by using a model in which at least the model number, the item state level, and the payment schedule are set as an input, and the residual price is set as an output. The model is designed so that an appropriate residual price is set in consideration of the model number, the item state level, and the payment schedule.

In addition, in the lease contract condition setting process, in a case of extending the lease contract after the payment lease charge is paid at all payment dates in accordance with the payment schedule, a payment date and a payment lease charge to be paid at each payment date are set. Hereinafter, a combination of each payment, date and the amount of the payment lease charge to be paid at each payment date after extending the lease contract is referred to as “payment schedule after extension”. The contract unit 21 sets the payment schedule after extension by using a model that outputs the payment schedule after extension by reflecting the total lease charge, the model number, and the item state level as in the payment schedule. In addition, in the lease contract condition setting process, a residual price (hereinafter, referred to as “residual price after extension”) of the target item when the payment schedule after extension is completed is set. The contract unit 21 sets the residual price by using a model in which at least the model number, the item state level, the payment schedule, and the payment schedule after extension are set as an input, and the residual price after extension is set as an output.

The contract unit 21 updates values of the payment schedule information of the record of the target contract in the contract management database 26, the residual price information, the payment schedule information after extension, and the residual price information after extension on the basis of results in the lease contract condition setting process. Note that, in this embodiment, the payment schedule, the payment schedule after extension, the residual price, and the residual price after extension are set by using the model, but the information may be set by using another method. For example, a person in charge of the service providing company may artificially set and input the information, or contents of the information may be artificially adjusted after the information is set through information processing by means using the model.

After executing the lease contract condition setting process, the contract unit 21 notifies the user terminal 2A of a message indicating that assessment is terminated and a lease contract can be made through a push notification (step SE6). As is well known, in the push notification, a message is given in notification to a target device regardless of whether or not an application (a dedicated application in this embodiment) is activated, and the message is displayed on a lock screen or an icon badge is displayed on an icon in correspondence with user's setting. Note that, a notification permission by the push notification from the target user is appropriately obtained in advance, and information (device identification information (device token) issued from the push notification system, or the like) necessary for the push notification is appropriately acquired in advance.

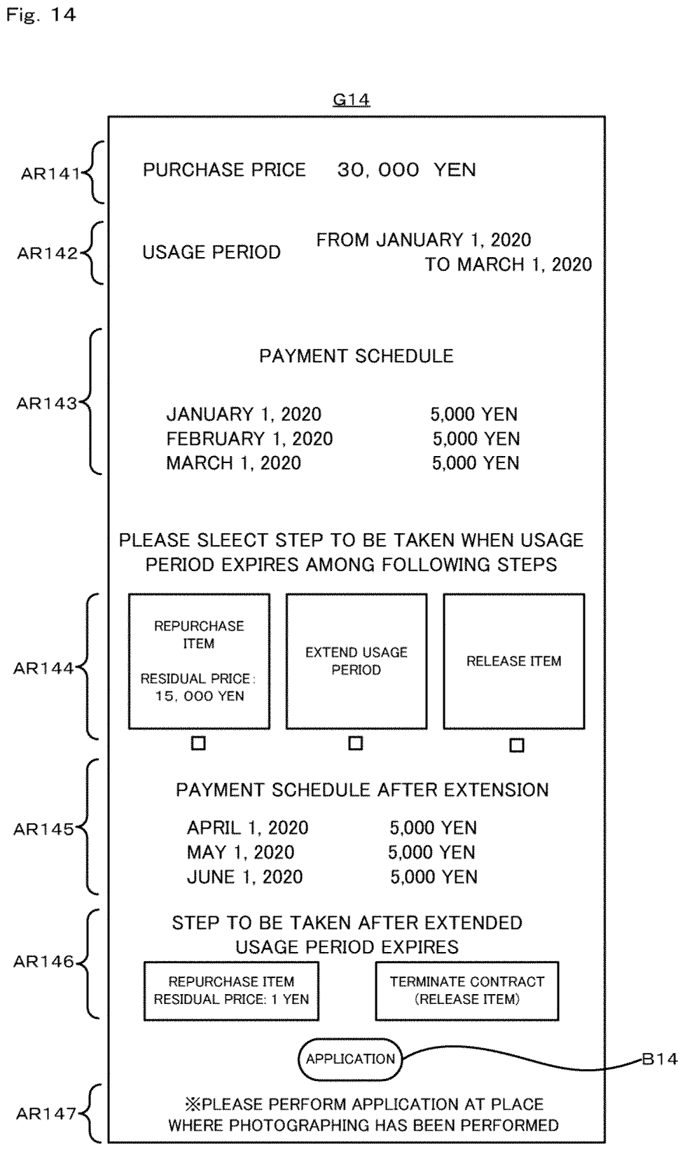

As illustrated in FIG. 13(A), the terminal-side control unit 31 of the user terminal 2A displays a message in correspondence with the push notification (step SD1). The target user who has confirmed the message recognizes that assessment is terminated and a lease contract can be made, activates the dedicated application, and performs a predetermined operation to make an instruction for display a confirmation screen G14 (FIG. 14). In correspondence with the instruction, the terminal-side control unit 31 displays the confirmation screen G14 on the touch panel 19A in cooperation with the contract unit 21 (step SD2). In addition, in the following description, a notification of the message from the functional block of the information processing device 1A to the user terminal 2A through push notification, an instruction for activation of the dedicated application and display of a predetermined screen by the target user on the basis of the message, and display of the predetermined screen on the touch panel 19A in cooperation between the terminal-side control unit 31 and the functional block in correspondence with the instruction will be simply described as “the functional block transmits the push notification, and the terminal-side control unit 31 displays the predetermined screen in cooperation with the functional block”. Note that, in this embodiment, the notification is given through the push notification, but the notification can be given by other means such as a mail.

FIG. 14 is a view illustrating the confirmation screen G14. As illustrated in FIG. 14, a purchase price is displayed on the confirmation screen G14 (refer to an area AR141). In addition, a usage period is displayed on the confirmation screen G14 (refer to an area AR142). The usage period represents a period until payment of the lease charge is completed from the present date as a starting point (=a period until reaching a final payment date). In addition, a payment schedule is displayed on the confirmation screen G14 (refer to an area AR143). In addition, information indicating the following three actions which the target user can take after paying the payment lease charge in accordance with the payment schedule and passage of the usage period is displayed on the confirmation screen G14 (refer to an area AR144).

A first action is an action of repurchasing the target item by paying the residual price, and the residual price is displayed in information indicating the action. Hereinafter, the first action is referred to as “item repurchasing action”. A second action is an action of extending the lease contract. In a case of taking the second action, the payment lease charge will be paid in accordance with the payment schedule after extension, and on the basis of this, the payment schedule after extension is displayed on the confirmation screen G14 (refer to an area AR145). In an area where the payment schedule after extension is displayed, two actions which can be taken after the payment schedule after extension is completed are displayed (refer to an area AR146). Hereinafter, the second action is referred to as “lease extension action”. A third action is an action of releasing the item. Hereinafter, the third action is referred to as “item release action”.

Each of a plurality pieces of the information indicating three actions is associated with a check box, and a user can select an action to be taken by checking a check box. However, selection of an action to take after the payment schedule is completed can also be taken after a lease contract is made instead of the timing, or the selection can also be changed afterward. Note that, information on the usage period which is displayed on the confirmation screen G14, information on the payment date, information that can be taken after the payment schedule is completed, and the like correspond to “various conditions relating to a lease contract” in the appended claims. That is, the contract unit 21 notifies a user of contract related information including the purchase price acquired by the assessment unit 20, the lease charge when leasing an object to be purchased to the user, and various conditions relating to the lease contract through the network N.

As illustrated in FIG. 14, a button B14 for making an instruction for application to the lease contract is displayed on the confirmation screen G14. In addition, instructions of the gist indicating that application to the lease contract (=operation of the button B14) should be performed at a location where photographing of a target item has been performed is shown in association with the button B14 (refer to an area AR147). The target user touches the button B14 in a case where there is no problem, in contents of information displayed on the confirmation screen G11. Of course, the target user may not apply the lease contract. When the button B14 is operated, the terminal-side control unit 31 acquires information (hereinafter, referred to as “contract position information”) indicating a position of the user terminal 2A (=a current position of the target user) at the current point of time by a position detection function of the user terminal 2A, and transmits the information to the contract unit 21 (step SD3). The contract unit 21 receives the contract position information and updates a value of the contract position information of a record of a target contract in the contract management database 28 (step SE7).

Next, the contract unit 21 acquires photographing position information of the record of the target application in the application management database (step SE8). Next, the contract unit 21 determines whether or not a position (photographing position) indicated by the photographing position information and a position (contract position) indicated by the contract position information have uniformity (step SE9). Description of “the position indicated by the photographing position information and the position indicated by the contract position information have uniformity” represents that the position indicated by the photographing position information and the position indicated by the contract position information are close to each other to a certain extent in which the positions are regarded as being located in the same space. For example, when a spaced distance between the position indicated by the photographing position information and the position indicated by the contract position information is less than a threshold value, it is determined that the positions have uniformity.

In a case where there is uniformity (step SE9: YES), the contract unit 21 and the terminal-side control unit 31 executes a contract acceptance process in cooperation with each other (steps SD4 and SE10). Specifically, the contract unit 21 controls the terminal-side control unit 31, and causes the touch panel 19A to display a display screen displaying a usage rule and a button to be touched in agreement of contents of the usage rule. The target user confirms contents of the usage contract displayed on the screen, and touches the button when agreeing with the contents. When the button is touched, the terminal-side control unit 31 notifies the contract unit 21 of the gist. The contract unit 21 turns on a contract completion flag in the contract management database 28. A process of turning on the contract completion flag corresponds to a process of accepting the lease contract. As described above, a purchase related contract and a lease contract are concluded between the target user and the service providing company, and application for the lease contract by the target user is completed.

On the other hand, in a case where there is no uniformity (step SE9: NO), the contract unit 21 does not accept the lease contract and the target item purchase related contract and executes a corresponding process (step SE11). For example, the contract unit 21 causes the terminal-side control unit 31 to display the following screen instead of the screen on which the usage rule is displayed. The screen is a screen displaying information of the gist indicating that since the position where the target item is photographed and the current position are different from each other, the purchase related contract and the lease contract cannot be concluded at a current point of time and an operation should be performed after moving to a location where photographing of the target item has been performed.

As described above, in this embodiment, in a case where there is no uniformity between the position where photographing of the target item has been performed, and the position where the contract related work (specifically, an operation of the button B14 of the confirmation screen G11 (hereinafter, referred to as “contract related work”)) has been performed, the contract unit 21 does not accept the lease contract (=the target user cannot conclude the purchase related contract and the lease contract). The reason for this is as follows. Specifically, the target item is necessary to be owned by the target user, and in usage of this service, it is assumed that photographing of the target item and the contract related work are performed in a home or a private space where possessions of an individual can be disposed (hereinafter, referred to as “home or the like”) in combination, and a user is informed that the photographing and the work should be done as described above. In addition, in a case where both the photographing of the target item and the contract related work are performed in the home or the like, a position where the photographing of the target item has been performed and a position where the contract related work has been performed have uniformity.

On the basis of this, the contract unit 21 regards that both the photographing of the target item and the contract related work have been performed at the home or the like in a case where the respective positions have uniformity, and accepts the purchase related contract and the lease contract. On the other hand, in a case where the respective positions do not have uniformity, the contract unit 21 does not accept the purchase related contract and the lease contract, for example, on the assumption that an item is in a location other than the home or the like and is not owned by a user may have been photographed, and the contract related work may have been performed at a location other than the location. The above-described configuration contributes to an aspect in which each contract is made only in a case where the photographed target item is owned by the target user with regard to a circumstance which is a peculiar to this service and in which the target user is not necessary to hand over the target item to an assessor in a face-to-face manner and may transmit the photographing data based on the photographing result through the network N. It can be said that the configuration is a unique device based on the circumstance peculiar to this service.

Note that, in this embodiment, it is determined whether or not each contract can be concluded depending on whether or not a position where photographing of a target item has been performed and a position where a contract related work has been performed have uniformity, but the following configuration may be employed. Specifically, the contract unit 21 acquires a position when photographing has been performed, acquires a position (position that is registered in advance as a user related position) indicated by an address registered in advance as the home or the like, and does not accept a contract in a case where the respective positions have no uniformity. According to this configuration, each contract is accepted only in a case where photographing of a target item has been performed at the home or the like, and thus it is possible to reduce a possibility that an item that is not owned by a user is handled in this service. Note that, in a case of this configuration, at the time of photographing, the user is notified that photographing should be performed at the address registered in advance.

In addition, the following configuration may also be employed. Specifically, the contract unit 21 acquires a position when photographing has been performed, a position indicated by an address registered in advance as the home or the like (position that is registered in advance as a user related position), and a position of a user when application for a contract has been made from the user after notification of contract related information, and in a case where the position when photographing has been performed and the position registered in advance have no uniformity, or in a case where the position of the user when the application has been made and the position registered in advance have not uniformity, the contract unit 21 does not accept the contract. According to this configuration, each contract can be accepted only in a case where both the photographing of the target item and the contract related work have been performed at the home or the like, and thus it is possible to reduce a possibility that an item that is not owned by the user is handled in this service. Note that, in a case of this configuration, at the time of photographing and the contract related work, the user is notified that photographing should be performed at the address registered in advance.

<Contract Management Scene>

Next, a contract management scene will be described. The contract management scene is a scene until a lease contract is terminated after conclusion of a contract relating to purchase of a target item and the lease contract. The contract management unit 22 pays a purchase price to the target user. A method of paying the purchase price to the target user is selected by the target user at the time of member registration, and the method is registered as a method of providing the purchase price in a record of the target user in the user information database 25. In member registration, the control unit 12A of the information processing device 1A suggests various methods which can be selected as the payment method of the purchase price by causing the terminal-side control unit 31 of the user terminal 2A to display a predetermined screen, and the target user selects one method among the methods. The contract management unit 22 completes payment of the purchase price to the target user with reference to the payment method of the purchase price in the record of the target user in the user information database 25, and in cooperation with other systems as necessary.

An example of the payment method of the purchase price includes a method in which a service providing company sends the purchase price to the target user by using a fund transfer service, and the target user receives the purchase price with a cash or an electronic money by using ATM. In this case, after a necessary contract is concluded between a fund transfer service providing company and the service providing company, a state in which the contract management unit 22 can execute remittance by using the fund transfer service is constructed. In addition, in this case, the contract management unit 22 sends the purchase price by taking a necessary step with respect to a system related to the fund transfer service, and the user acquires information (a partner code, a customer number, a confirmation number, and the like to be input to the ATM. Hereinafter, referred to as “input information”) necessary when the target user receives the purchase price from the system, by using the ATM.

The contract management unit 22 notifies the target user of the input information by a notification using a predetermined screen provided by a dedicated application (in this case, activation of a dedicated screen and display of the predetermined screen may be promoted by using a push notification), a mail, and other means. The target user inputs the input information with a predetermined ATM, and receives the purchase price with a cash or an electronic money. Examples of other payment methods include appropriation of the purchase price to a digital wallet, appropriation of points corresponding to the purchase price to an existing point system, transfer to an account, provision of a prepaid card, and the like.

When reception of the purchase price is completed by the target user, the contract management unit 22 detects the state. Which state is set as completion of reception of the purchase price is determined for every payment method, and when reception of the purchase price is completed, the contract management unit 22 detects the completion by a predetermined method corresponding to the payment method. For example, in a case where the payment method is the method using the fund transfer service, when the user receives the purchase price by using the ATM, a system relating to the fund transfer service detects the reception, and notifies the contract management unit 22 of the reception. The contract management unit 22 detects that reception of the purchase price has been completed by the target user on the basis of the notification. In addition, for example, the payment method is the appropriation of the purchase price to the digital wallet, appropriation of points to the point system, or transfer to the account, when the appropriation or the transfer has been completed, the contract management unit 22 is notified of the completion, and the contract management unit 22 detects that reception of the purchase price has been completed by the target user on the basis of the notification.

When detecting that reception of the purchase price has been completed by the target user, the contract management unit 22 executes an occupancy revision confirmation process in cooperation with the terminal-side control unit 31, and notifies the target user of information on the occupancy revision. Hereinafter, the occupancy revision confirmation process will be described in detail. In the occupancy revision confirmation process, the contract management unit 22 transmits a push notification, and the terminal-side control unit 31 displays an occupancy revision confirmation screen in cooperation with the contract management unit 22. The gist indicating that the target user shows intension of occupying the target item as an agency for the service providing company, and the gist indicating that proxy occupancy (indirect occupancy) is transferred to the service providing company through reception of the purchase price are displayed on the occupancy revision confirmation screen. The target user confirms that the target user shows intension of occupying the target item as an agency for the service providing company, and proxy occupancy is transferred to the service providing company with reference to the contents of: the occupancy revision confirmation screen.

Then, basically, the target user pays a payment lease charge in accordance with a payment schedule. Payment of the payment lease charge is performed by one method selected by the target user among a plurality of methods suggested to the target user at predetermined timing (for example, timing at which user registration is performed or timing immediately before or after the contract is concluded). Examples of the payment method include payment by a credit card, payment using a deferred payment service, transfer to an account, and the like. lease charge reception method information including information necessary to receive the lease charge paid by the payment method selected by the target user is registered in the record of the target user in the user information database 25.

The contract management unit 22 accepts payment of the lease charge, and manages a user's lease charge payment situation based on the lease contract. The contract management unit 22 manages a payment situation of the payment lease charge by the target user by using payment situation management data in the contract management database 28. More specifically, whenever payment of the payment lease charge toy the target user is performed, the contract management unit 22 detects the payment in cooperation with another system relating to the payment, and records information indicating a payment date and the amount of money in the payment situation management data in an appropriate aspect.

Furthermore, the contract management unit 22 monitors whether or not payment is performed in accordance with a payment schedule with reference to payment schedule information of a record of target contract in the contract management database 28. As a simple example, in nighttime batch processing performed after one day has passed, the contract management unit 22 determines whether or not payment up to the previous day is completed with respect to a contract in which the previous day is a payment date among lease contracts of respective users.

With regard to payment by the target user, a case where payment is performed in accordance with the payment schedule (corresponding to “case where payment has been completed in accordance with a predetermined conditions”. Hereinafter, this case is referred to as “first case”), a case where the user makes a request for cancellation of the lease contract before expiration of a usage period (corresponding to “case where the user desires”. Hereinafter, this case is referred to as “second case”), and a case where payment has not been performed in accordance with the payment schedule (corresponding to “case where payment has not been performed in accordance with a predetermined condition”. Hereinafter, this case is referred to as “third case”) are considered. The third case represents that the payment lease charge is not paid up to any one payment date. Hereinafter, description will be given of an operation of the contract management unit 22 in each of the cases.

<First Case>

In the first case, when payment has been performed at a final payment date, the contract management unit 22 detects the completion. In the first case, in a case where the target user selects an item repurchase action, the contract management unit 22 guides information such as a residual price, a payment deadline, and a payment method for the residual price which are necessary for the target user to pay the residual price. When the target user pays the residual price, the ownership of the target item is transferred to the target user, and the contract management unit 22 notifies the target user of the transfer of the ownership to the target user. In addition, the contract management unit 22 turns on a contract termination flag of the record of the target contract in the contract management database 28. A process of turning on the contract termination flag corresponds to a process of terminating the lease contract. Note that, in this embodiment, payment of the payment lease charge and payment of the residual price are set to different steps. However, in a case where the item repurchase action is selected, the target user may pay the residual price by the same method as in the payment lease charge with a predetermined interval after payment of the payment lease charge on the last day of the payment date.

In addition, in the first case, in a case where the user selects a lease extension action, it is necessary for the target user to pay the payment lease charge after extension in accordance with a payment schedule after extension. The contract management unit 22 manages a payment situation by the same method as before extension of the usage period on the basis of the payment schedule after extension of the record of the target contract in the contract management database 28, and copes with each of a case where payment according to a schedule has been completed, a case where payment according to the schedule has not been completed, and a case where application for cancellation of the lease contract has made in the middle of the schedule by the same method as before extension of the lease contract.

In addition, in a case where the target user selects item release correspondence in the first case, it is necessary for the target user to return the target item to the service providing company. In this embodiment, a contract is concluded with a company that provides a pickup service in advance, and the target item is collected from the target user by using the pickup service. The pickup service represents that a trader goes to a user's place at a date agreed with the user, and collects the item from, the user. In this embodiment, when the target item is released, it is not necessary for the user to send the item to a service providing company's place, or to bring the item to a place where a delivery is received, and thus convenience of the user is realized.

The contract management unit 22 provides information on the target user to a system of a pickup service providing company, and gives a notification of information necessary for the target user in order for pickup of the target item to be performed (to prepare pickup of an object). Exchange relating to pickup may be performed between the pickup service providing company and the target, user.

The target item that is picked up by using the pickup service is brought to the service providing company, and various kinds of verification are performed by a person in charge of the company. The various kinds of verification are performed from the viewpoint whether an item received from the target user is an assumed item, and the viewpoint that a state of the item received from, the target user is in an assumed state. For example, in the various kinds of verification, whether the item is a photographed item, whether the item is a genuine item, whether there is no difference from the deepest classification set by the target user, whether there is no failure, whether there is no defect of a part, and whether there is no inconsistency in contents in system information photographing data, and the like are verified. The person in charge determines the returned item evaluation value for evaluating the target item through the various kinds of verification, and operates the data input unit 6 to input the returned item evaluation value to the information processing device 1A. In correspondence with the input of the returned item evaluation value, the contract management unit 22 updates the returned item evaluation value in the record of the target contract in the contract management database 28. In addition, the contract management unit 22 turns on the contract termination flag of the record of the target contract in the contract management database 28 (terminates the contract).

Note that, the returned item may foe different from the photographed item, or may deteriorate in an abnormal aspect. In this case, the service providing company performs a corresponding process such as contact with the target user. In addition, the contract management unit 22 turns on a violation flag of the record of the target contract in the contract management database 28.

<Second Case>

In a case of receiving a request for cancellation of the lease contract from the target user during the lease contract period, the contract management unit 22 takes a step of recovering the target item from the target user to terminate the lease contract (to prepare recovery). Recovery of the target item is performed by a method using the above-described pickup service. In addition, after recovery of the target item, the contract management unit 22 updates the returned item evaluation value of the record of the target contract in the contract management database 28 on the basis of an input from a person in charge who has verified the returned item, and turns on the violation flag as necessary, and further turns on the contract termination flag (terminates the contract).

<Third Case>

In a case where payment of the payment lease charge up to the payment date has not performed during the lease contract period, the contract management unit 22 turns on the violation flag of the record of the target contract in the contract management database 28. Furthermore, the contract management unit 22 acquires a user score of a record of the target user in the user information database 25, and determines whether or not the user score exceeds a threshold value. This process corresponds to a process of examining whether or not the payment period can be extended from a past usage history of the user. In a case where the user score falls below the threshold value, the contract management unit 22 takes a step of recovering the target item. In addition, after recovery of the target item, the contract management unit 22 updates the returned item evaluation value of the record of the target contract in the contract management database 28 on the basis of an input from a person in charge who has verified the returned item, and turns on the violation flag as necessary, and further turns on the contract termination flag (terminates the contract).

On the other hand, in a case where the user score exceeds the threshold value, the contract management unit 22 transmits a push notification, and the terminal-side control unit 31 displays an extension possible notification screen on the touch panel 19A in cooperation with the contract management unit 22. In the extension possible notification screen, information indicating that it is possible to continue the lease contract by performing payment in accordance with a schedule that is set again is displayed. In addition, the extension possible notification screen is configured to select continuation of the lease contract or returning of the target item through a touch operation.

In a case where returning of the target item is selected, the contract management unit 22 takes a step of recovering the target item. In addition, after recovery of the target item, the contract management unit 22 updates the returned item evaluation value of the record of the target contract in the contract management database 28 on the basis of an input from a person in charge who has verified the returned item, and turns on the violation flag as necessary, and further turns on the contract termination flag (terminates the contract). On the other hand, in a case where continuation of the lease contract is selected by the target user, the contract management unit 22 adjusts the payment schedule, and manages a payment situation of the payment lease charge again on the basis of the adjusted payment schedule. With regard to the adjustment of the payment schedule, the contract management unit 22 performs adjustment of time extension for each of payment dates for which payment of the payment lease charge has not been completed. As described above, in this embodiment, in a case where payment of the payment lease charge has not been performed in accordance with a predetermined condition, the contract management unit 22 suggests extension of the payment period of the lease charge to the user in a case where it is determined that the payment period can be extended from the past usage history of the user.

<Usage History Verification Scene>

Next, description will be given of the usage history verification scene. The usage history verification scene is a scene in which the user score is set by the usage history verification unit 23. Here, as described in the contract management scene, a record relating to a terminated lease contract (record in which the contract termination flag is turned on) is accumulated in the contract management database 28. Hereinafter, description will be given of an operation of the usage history verification unit 23 on the assumption that a plurality of terminated lease contracts exist with regard to the target user, and each of records corresponding to the terminated lease contracts is registered in the contract management database 28. Hereinafter, payment elapse of the payment lease charge and returning of an illegal item are collectively referred to as “violation action”. In a case where the violation action is taken in an arbitrary lease contract, it enters a state in which the violation flag of the record of the lease contract in the contract management database 28 is turned on.

The usage history verification unit 23 initiates the following process at predetermined timing. For example, the predetermined timing is timing at which a record in which the termination flag is turned on newly appears for the target user. First, the usage history verification unit 23 specifies a record in which the contract termination flag is turned on among records relating to the target user registered in the contract management database 28. In this example, a plurality of records are specified. Then, the usage history verification unit 23 recognizes a value of a violation flag of each of the specified records, and a returned item evaluation value. Then, the usage history verification unit 23 derives the user score by a calculation method in which a value becomes large as a violation action does not occur and the returned item evaluation value is large in the past lease contract. The user score derived in this manner is based on the usage history of this service by the target user, and becomes a score that takes a large value as the probability of the violation action by the target user is assumed to be lower. Note that, the method of deriving the user score is simplified, and the user score may be derived by adding other elements.

As described above in detail, in this embodiment, the information processing device 1A is configured to acquire information on a target item owned by the target user, to acquire the purchase price on the basis of the acquired information on an object, to accept the lease contract by notifying the user of the acquired purchase price, the lease charge when leasing an object to be purchased to the user, and various conditions relating to the lease contract, to pay the purchase price to the user and to accept payment of the lease charge, and to manage a payment situation of the lease charge by the user on the basis of the lease contract. According to the invention configured as described above, the user can raise a fund corresponding to the purchase price by easy means of transmitting information (in this embodiment, photographing data) relating to an object owned by the user through a network without actually going to a store or without interacting with the assessor in a face-to-face manner. In addition, provision of the purchase price to the user is based on a lease contract that is concluded after the purchase price based on information on the target item is acquired, and the purchase price, the lease charge, and the various conditions relating to the lease contract are presented to the user, through a network, and the user can raise a fund while maintaining a state in which the possession can be used under the condition of payment of the lease charge.

Hereinbefore, an embodiment of the invention has been described, but the embodiment is merely an example of embodiment when carrying out the invention, and a technical scope of the invention should not be interpreted in a limited manner by the embodiment. That is, the invention can be carried out in various aspects without departing from, the gist of the invention or main characteristics thereof.

For example, in the embodiments, description has been given with focus given to information processing/operation processing by respective devices, and even not being particularly described, a process necessary based on the law, the ordinance, or the other rules in a country or a region in which a service is provided (for example, notification of information that is necessary to be given in notification to a user due to a request of the law or the ordinance) is executed of course.

In addition, in the embodiments, the payment method of the purchase price from the service providing company to the user, or the payment method of the payment lease charge from, the user to the service providing company may be configured to be determined for every contract.

In addition, in the first embodiment, the storage unit 13 is configured to be provided in the information processing device 1. However, it is not necessary for the storage unit 13 to be provided in the information processing device 1, and may be provided in a device that is externally connected to the information processing device 1, or may be provided in another server that can communicate with the information processing device 1 through the network N. This is also true of the second embodiment. In addition, with regard to the second embodiment, guarantee acceptance by a guarantee company, or determination using the user score may not be performed.

### REFERENCE SIGNS LIST

1, 1A Information processing device
2, 2A User terminal
3, 3A Guarantee taking-over company server device
4, 4A Market price information DB device
11 Communication unit
12, 12A Control unit
12-2, 20 Assessment unit
12-3, 21 Contract unit
12-5, 22 Contract management unit
13, 13A Storage unit
13-1 User information
13-2 Object information
13-3 Lease charge receipt situation
13-4 Lease usage history
13-5 Evaluation in returning lease item
100, 100A Information processing system
N Communication network

1. An information processing device, comprising:
an assessment unit that acquires one or more pieces of photographing data generated when an object owned by a user is photographed through a network, and acquires a purchase price based on the one or more pieces of photographing data at the time of purchasing the object;
a contract unit that notifies a user of contract related information including the purchase price acquired by the assessment unit, a lease charge when leasing the object to be purchased to the user, and various conditions relating to a lease contract through the network, and accepts the lease contract; and
a contract management unit that pays the purchase price to the user, accepts payment of the lease charge, and manages a user's lease charge payment situation based on the lease contract.

2. The information processing device according to claim 1,
wherein the contract management unit terminates the lease contract and gives a notification of transfer of the ownership of the object to the user in a case where payment is completed in accordance with a predetermined condition.

3. The information processing device according to claim 1,
wherein in a case where payment of the lease charge has not been performed in accordance with the predetermined condition or in a case where user desires, the contract management unit prepares recovery of the object and terminates the lease contract.

4. The information processing device according to claim 3,
wherein in a case where payment of the lease charge is not performed in accordance with the predetermined condition, the contract management unit suggests extension of a payment period of the lease charge to the user in a predetermined case.

5. The information processing device according to claim 4,
wherein in a case where payment of the lease charge is not performed in accordance with the predetermined condition, the contract management unit suggests extension of the payment period of the lease charge to the user in a case where it can be determined that the payment period can be extended from a past usage history of the user.

6. (canceled)

7. The information processing device according to claim 1,
wherein when photographing for generating the photographing data is performed by the user, the assessment unit acquires a classification of the object prior to the photographing, and displays a screen showing a photographing method corresponding to the classification of the object on a user's terminal.

8. The information processing device according to claim 1,
wherein the assessment unit performs analysis by image processing with respect to the one or more pieces of photographing data, and derives and acquires the purchase price by reflecting a result of the analysis or acquires the purchase price derived after reflection of the result of the analysis.

9. The information processing device according to claim 8,
wherein the photographing data includes data generated by photographing an authenticity determination target included in the object, and
the assessment unit executes an authenticity determination by image processing by using an image of the authenticity determination target which is included in the photographing data, and does not derive the purchase price or prevents the purchase price from being derived, and executes a corresponding process in a case where a determination is made as not being genuine.

10. The information processing device according to claim 9,
wherein when photographing for generating the photographing data is performed by a user, the assessment unit acquires a classification of an object prior to the photographing, and in a case of a classification including the authenticity determination target, the assessment unit displays a screen showing a photographing method in which the authenticity determination target is set to be photographed on the user's terminal.

11. The information processing device according to claim 8,
wherein the photographing data includes data generated by photographing a site where deterioration can appear or is likely to appear in the object, and
the assessment unit detects the degree of deterioration by image processing with respect to the photographing data, and derives and acquires the purchase price by reflecting the detected degree of deterioration, or acquires the purchase price derived by reflecting the detected degree of deterioration.

12. The information processing device according to claim 11,
wherein when photographing for generating the photographing data is performed by a user, the assessment unit acquires a classification of an object prior to the photographing, and displays a screen showing a photographing method in which a site where deterioration is able to appear or is likely to appear in the object is set to be photographed on a user's terminal in correspondence with the classification of the object.

13. The information processing device according to claim 8,
wherein in a case where the object is a device capable of displaying system information, the photographing data includes data generated by photographing displayed system information, and
the assessment unit acquires information by performing optical character recognition with respect to the photographing data, and derives and acquires the purchase price by using the acquired information or acquires the purchase price derived by using the acquired information.

14. The information processing device according to claim 13,
wherein when photographing for generating the photographing data is performed by a user, the assessment unit acquires the classification of the object prior to the photographing, and in case of a classification corresponding to a device capable of displaying system information, the assessment unit displays a screen showing a photographing method in which the displayed system information is set to be photographed on the user's terminal.

15. The information processing device according to claim 1,
wherein the contract unit acquires a position when photographing has been performed, and in a case where the user applies for a contract after a notification of the contract related information, the contract unit acquires a position of the user, and does not accept the contract in a case where there is no uniformity between the positions.

16. The information processing device according to claim 1,
wherein the contract unit acquires a position when photographing has been performed, acquires a position that is registered in advance as a user related position, and does not accept the contract in a case where there is no uniformity between the positions.

17. The information processing device according to claim 1,
wherein the contract unit,
acquires a position when photographing has been performed, a position that is registered in advance as a user related position, and a position of the user in a case where the user has applied for a contract after a notification of the contract related information, and
does not accept the contract in a case where the position when photographing has been performed and the position registered in advance have not uniformity, or in a case where the position of the user when the user has applied for the contract and the position registered in advance have no uniformity.

18. The information processing device according to claim 1,
wherein when the user has received the purchase price, the contract management unit detects the reception, and notifies the user of information on occupancy revision.

19. (canceled)

20. (canceled)

21. (canceled)

22. An information processing device, comprising:
an assessment unit that acquires information on an object owned by a user through a network, and acquires a purchase price based on the acquired information on the object at the time of purchasing the object;
a contract unit that notifies a user of contract related information including the purchase price acquired by the assessment unit, a lease charge when leasing the object to be purchased to the user, and various conditions relating to a lease contract through the network, and accepts the lease contract; and
a contract management unit that pays the purchase price to the user, accepts payment of the lease charge, and manages a user's lease charge payment situation based on the lease contract, wherein
in a case where payment of the lease charge has not been performed in accordance with the predetermined condition or in a case where user desires, the contract management unit prepares recovery of the object and terminates the lease contract,
in a case where payment of the lease charge is not performed in accordance with the predetermined condition, the contract management unit suggests extension of a payment period of the lease charge to the user in a predetermined case.

23. The information processing device according to claim 22,
wherein in a case where payment of the lease charge is not performed in accordance with the predetermined condition, the contract management unit suggests extension of the payment period of the lease charge to the user in a case where it can be determined that the payment period can be extended from a past usage history of the user.

24. An information processing device, comprising:
an assessment unit that acquires information on an object owned by a user through a network, and acquires a purchase price based on the acquired information on the object at the time of purchasing the object;
a contract unit that notifies a user of contract related information including the purchase price acquired by the assessment unit, a lease charge when leasing the object to be purchased to the user, and various conditions relating to a lease contract through the network, and accepts the lease contract; and
a contract management unit that pays the purchase price to the user, accepts payment of the lease charge, and manages a user's lease charge payment situation based on the lease contract, wherein
when the user has received the purchase price, the contract management unit detects the reception, and notifies the user of information on occupancy revision.
